(19) United States
(12) Patent Application Publication
(10) Pub. No.: US 2013/0337957 A1
(43) Pub. Date: Dec. 19, 2013

(54) Segmented ground gear transmission (SGGT)

(71) Applicant: John M. Vranish, Crofton, MD (US)

(72) Inventor: John M. Vranish, Crofton, MD (US)

(21) Appl. No.: 13/507,299

(22) Filed: Jun. 19, 2012

(51) Int. Cl. F16H 15/50; F16H 25/12

(52) U.S. Cl. 475/149; 475/185; 74/89.23

(57) ABSTRACT

A Segmented Ground Gear Transmission (SGGT) is a two-stage epicyclical planetary transmission that converts input angular velocity and toque to a continuously variable output varying the effective diameter of ground stage ring gear. The ground stage ring gear is expanded and contracted in segments, half occupied by planets and half free. The segments occupied by planets transfer torque to ground, but do not move except in small angle twist for section curvature correction, while the free segments move in rotation to close the gaps between segments, but do not carry load. The ground stages of the two-stage planets displace to maintain correct mesh with and to correct curvature errors in the sections. The load-bearing segments and free segments exchange roles so the planets can rotate and orbit continuously for extended periods. Anti-friction rolling contacts are used throughout.

### CROSS REFERENCE TO RELATED APPLICATION

The invention is related to a series of inventions shown and described in Vranish, J. M., Gear Bearings, U.S. Pat. No. 6,626,792, Sep. 30, 2003, Vranish, J. M., Anti-Backlash Gear Bearings, U.S. Pat. No. 7,544,146, Jun. 9, 2009, Vranish, J. M., Modular Gear Bearings, U.S. Pat. No. 7,601,091, Oct. 13, 2009, Vranish, J. M., Partial Tooth Gear Bearings, U.S. Pat. No. 7,762,155 Jul. 27, 2010, Weinberg, Brian (Brookline, Mass.), Mavroidis, Constantinos (Arlington, Mass.) and Vranish, J. M. (Crofton, Md.), Gear Bearing Drive, U.S. Pat. No. 8,016,893 Sep. 13, 2011. Gear-Bearing technology is used extensively throughout Variable Ground Gear CVT as a means of achieving many of the detail operations needed to make the Variable Ground Gear CVT concept work in a practical sense. The rights to the inventions in which J. M. Vranish is the sole inventor are held by the United States Government and the rights to the invention with multiple inventors is held by Northeastern University. The teachings of these related applications are herein meant to be incorporated by reference.

### ORIGIN OF THE INVENTION

The invention was made by John M. Vranish as President of Vranish Innovative Technologies LLC without the payment of any royalties, therein or therefor. John M. Vranish is a former employee of NASA and worked on continuously variable planetary transmissions while at NASA. This invention is a continuation of his NASA efforts, but done by John M. Vranish on his own time and at his own expense.

### BACKGROUND OF THE INVENTION

This invention is the result of nearly twenty years of periodic efforts by John M. Vranish to find a way to get continuously variable performance from a geared two-stage planetary transmission. The initial work began around 1995 with the first failed attempt and received renewed emphasis in 2005 when John M. Vranish developed two-stage epicyclical planetary gear-bearing transmissions for precision positioning telescopes in NASA applications. The work attracted interest from the NASA commercialization group and efforts turned to finding a way to turn this concept into a continuously variable planetary transmission. The search for a geared CVPT failed repeatedly. Each new approach failed for one of three reasons. 1. The concept violated the “Tooth Count Dilemma”. That is, continuously variable shifting requires the ground ring gear to add teeth to retain proper mesh. 2. Solutions that provided a way around the “Tooth Count Problem,” didn't shift. The Ground gear teeth could move along the planets, but the output would not change. 3. Designs that used moveable grounds shifted speeds at the output, but did not provide mechanical advantage. Also these moveable grounds required extra energy and were wasteful.

The present invention divides the ground ring gear into sections so the ground ring gear can be expanded by moving the sections radially apart. There are twice as many sections as planets, so half the planets are occupied by stationary sections, while the unoccupied sections are free to close the gaps in advance of the orbiting planets. The sections can exchange roles and the planets can orbit for extended periods. In this way each planet can engage more teeth in one complete orbit than the total teeth in the sections and the equivalent of adding fractions of a tooth can be achieved. Also, the sections bearing load are stationary and the moving sections do not carry load, so operation is efficient. This left the problem of correcting the errors in curvature in each section that occur when the sections are spread apart. This problem was solved by rotating each section small angles to allow the sections to remain perpendicular to the planet at the point of contact, thereby correcting curvature errors. There were many other detailed problems that had to be resolved one by one to come up with a comprehensive practical solution and novel applications of Gear-Bearing technology were applied to resolve many of these detail problems. With the concept evolved to its present maturity, this invention disclosure was prepared.

### FIELD OF THE INVENTION

The invention relates to electromechanical devices and more particularly to epicyclical planetary devices. The invention relates to epicyclical planetary devices and more particularly to two-stage epicyclical planetary devices. The invention relates generally to two-stage epicyclical planetary gear devices and more particularly to two-stage epicyclical planetary gear-bearing devices. The invention relates to two-stage epicyclical planetary gear-bearing devices and more particularly to two-stage epicyclical planetary gear bearing devices with a segmented ground gear and a continuously variable output. The invention also relates generally to electromechanical power transmission devices and more particularly to automotive power transmission devices. The invention also relates generally to automotive power transmission devices and more particular to automotive power devices with a shift capability. The invention also relates generally to automotive power transmission devices with a shift capability and more particularly to automotive transmission devices with a continuously variable shift capability. The invention also relates to automotive transmission devices with a continuously variable shift capability and more particularly geared automotive transmission devices with a continuously variable shift capability.

### DESCRIPTION OF THE PRIOR ART

[The below description of prior art us repeated verbatim from Wikipedia-Continuously variable transmission-searched by JMV Jun. 8, 2012. The references in the copied article refer to sources in the Wikipedia article and can be searched from links in that article. From the author's knowledge and experience the Wikipedia summary seems a good starting point to understanding the relevant prior art. An exhaustive search seems very difficult. The CVT problem has been around since da Vinci. None of the listed prior art seems to use the same or even a similar approach as Segmented Ground Gear Transmission (SGGT).]

1. Variable-Diameter Pulley (VDP) or Reeves Drive

In this most common CVT system,[3] there are two V-belt pulleys that are split perpendicular to their axes of rotation, with a V-belt running between them. The gear ratio is changed by moving the two sheaves of one pulley closer together and the two sheaves of the other pulley farther apart. Due to the V-shaped cross section of the belt, this causes the belt to ride higher on one pulley and lower on the other. Doing this changes the effective diameters of the pulleys, which in turn changes the overall gear ratio. The distance between the pulleys does not change, and neither does the length of the belt, so changing the gear ratio means both pulleys must be adjusted (one bigger, the other smaller) simultaneously in order to maintain the proper amount of tension on the belt. The V-belt needs to be very stiff in the pulley's axial direction in order to make only short radial movements while sliding in and out of the pulleys. This can be achieved by a chain and not by homogeneous rubber. To dive out of the pulleys one side of the belt must push. This again can be done only with a chain. Each element of the chain has conical sides, which perfectly fit to the pulley if the belt is running on the outermost radius. As the belt moves into the pulleys the contact area gets smaller. The contact area is proportional to the number of elements, thus the chain has lots of very small elements. The shape of the elements is governed by the static of a column. The pulley-radial thickness of the belt is a compromise between maximum gear ratio and torque. For the same reason the axis between the pulleys is as thin as possible. A film of lubricant is applied to the pulleys. It needs to be thick enough so that the pulley and the belt never touch and it must be thin in order not to waste power when each element dives into the lubrication film. Additionally, the chain elements stabilize about 12 steel bands. Each band is thin enough so that it bends easily. If bending, it has a perfect conical surface on its side. In the stack of bands each band corresponds to a slightly different gear ratio, and thus they slide over each other and need oil between them. Also the outer bands slide through the stabilizing chain, while the center band can be used as the chain linkage. [note 1]

2. Toroidal or Roller-Based CVT (Extroid CVT)

Toroidal CVTs are made up of discs and rollers that transmit power between the discs. The discs can be pictured as two almost conical parts, point to point, with the sides dished such that the two parts could fill the central hole of a torus. One disc is the input, and the other is the output. Between the discs are rollers which vary the ratio and which transfer power from one side to the other. When the roller's axis is perpendicular to the axis of the near-conical parts, it contacts the near-conical parts at same-diameter locations and thus gives a 1:1 gear ratio. The roller can be moved along the axis of the near-conical parts, changing angle as needed to maintain contact. This will cause the roller to contact the near-conical parts at varying and distinct diameters, giving a gear ratio of something other than 1:1. Systems may be partial or full toroidal. Full toroidal systems are the most efficient design while partial toroidals may still require a torque converter, and hence lose efficiency.

Some toroidal systems are also infinitely variable, and the direction of thrust can be reversed within the CVT[4].

3. Magnetic CVT or mCVT

A magnetic continuous variable transmission system was developed at the University of Sheffield in 2006 and later commercialized.[5] mCVT is a variable magnetic transmission which gives an electrically controllable gear ratio. It can act as a power split device and can match a fixed input speed from a prime-mover to a variable load by importing/exporting electrical power through a variator path. The mCVT is of particular interest as a highly efficient power-split device for blended parallel hybrid vehicles, but also has potential applications in renewable energy, marine propulsion and industrial drive sectors.

4. Infinitely Variable Transmission (IVT)

A specific type of CVT is the infinitely variable transmission (IVT), in which the range of ratios of output shaft speed to input shaft speed includes a zero ratio that can be continuously approached from a defined “higher” ratio. A zero output speed (low gear) with a finite input speed implies an infinite input-to-output speed ratio, which can be continuously approached from a given finite input value with an IVT. Low gears are a reference to low ratios of output speed to input speed. This low ratio is taken to the extreme with IVTs, resulting in a “neutral”, or non-driving “low” gear limit, in which the output speed is zero. Unlike neutral in a normal automotive transmission, IVT output rotation may be prevented because the backdriving (reverse IVT operation) ratio may be infinite, resulting in impossibly high backdriving torque; ratcheting IVT output may freely rotate forward, though. The IVT dates back to before the 1930s; the original design converts rotary motion to oscillating motion and back to rotary motion using roller clutches.[6] The stroke of the intermediate oscillations is adjustable, varying the output speed of the shaft. This original design is still manufactured today, and an example and animation of this IVT can be found here. [7] Paul B. Pires created a more compact (radially symmetric) variation that employs a ratchet mechanism instead of roller clutches, so it doesn't have to rely on friction to drive the output. An article and sketch of this variation can be found here [8] Most IVTs result from the combination of a CVT with a planetary gear system (which is also known as an epicyclic gear system) which enforces an IVT output shaft rotation speed which is equal to the difference between two other speeds within the IVT. This IVT configuration uses its CVT as a continuously variable regulator (CVR) of the rotation speed of any one of the three rotators of the planetary gear system (PGS). If two of the PGS rotator speeds are the input and output of the CVR, there is a setting of the CVR that results in the IVT output speed of zero. The maximum output/input ratio can be chosen from infinite practical possibilities through selection of additional input or output gear, pulley or sprocket sizes without affecting the zero output or the continuity of the whole system. The IVT is always engaged, even during its zero output adjustment.

IVTs can in some implementations offer better efficiency when compared to other CVTs as in the preferred range of operation because most of the power flows through the planetary gear system and not the controlling CVR. Torque transmission capability can also be increased. There's also possibility to stage power splits for further increase in efficiency, torque transmission capability and better maintenance of efficiency over a wide gear ratio range. An example of a true IVT is the Hydristor because the front unit connected to the engine can displace from zero to 27 cubic inches per revolution forward and zero to −10 cubic inches per revolution reverse. The rear unit is capable of zero to 75 cubic inches per revolution. However, whether this design enters production remains to be seen. Another example of a true IVT that has been put into recent production[9] and which continues under commercial development[10] is that of Torotrak.

5. Ratchetting CVT

The ratcheting CVT is a transmission that relies on static friction and is based on a set of elements that successively become engaged and then disengaged between the driving system and the driven system, often using oscillating or indexing motion in conjunction with one-way clutches or ratchets that rectify and sum only “forward” motion. The transmission ratio is adjusted by changing linkage geometry within the oscillating elements, so that the summed maximum linkage speed is adjusted, even when the average linkage speed remains constant. Power is transferred from input to output only when the clutch or ratchet is engaged, and therefore when it is locked into a static friction mode where the driving & driven rotating surfaces momentarily rotate together without slippage. These CVTs can transfer substantial torque, because their static friction actually increases relative to torque throughput, so slippage is impossible in properly designed systems. Efficiency is generally high, because most of the dynamic friction is caused by very slight transitional clutch speed changes. The drawback to ratcheting CVTs is vibration caused by the successive transition in speed required to accelerate the element, which must supplant the previously operating and decelerating, power transmitting element. Ratcheting CVTs are distinguished from VDPs and roller-based CVTs by being static friction-based devices, as opposed to being dynamic friction-based devices that waste significant energy through slippage of twisting surfaces. An example of a ratcheting CVT is one prototyped as a bicycle transmission protected under U.S. Pat. No. 5,516,132 in which strong pedalling torque causes this mechanism to react against the spring, moving the ring gear/chainwheel assembly toward a concentric, lower gear position. When the pedaling torque relaxes to lower levels, the transmission self-adjusts toward higher gears, accompanied by an increase in transmission vibration.

6. Hydrostatic CVTs

Hydrostatic transmissions use a variable displacement pump and a hydraulic motor. All power is transmitted by hydraulic fluid. These types can generally transmit more torque, but can be sensitive to contamination. Some designs are also very expensive. However, they have the advantage that the hydraulic motor can be mounted directly to the wheel hub, allowing a more flexible suspension system and eliminating efficiency losses from friction in the drive shaft and differential components. This type of transmission is relatively easy to use because all forward and reverse speeds can be accessed using a single lever. An integrated hydrostatic transaxle (IHT) uses a single housing for both hydraulic elements and gear-reducing elements. This type of transmission has been effectively applied to a variety of inexpensive and expensive versions of ridden lawn mowers and garden tractors. One class of riding lawn mower that has recently gained in popularity with consumers is zero turning radius mowers. These mowers have traditionally been powered with wheel hub mounted hydraulic motors driven by continuously variable pumps, but this design is relatively expensive. Some heavy equipment may also be propelled by a hydrostatic transmission; e.g. agricultural machinery including foragers, combines, and some tractors. A variety of heavy earth-moving equipment manufactured by Caterpillar Inc., e.g. compact and small wheel loaders, track type loaders and tractors, skid-steered loaders and asphalt compactors use hydrostatic transmission. Hydrostatic CVTs are usually not used for extended duration high torque applications due to the heat that is generated by the flowing oil. The Honda DN-01 motorcycle is the first road-going consumer vehicle with hydrostatic drive that employs a variable displacement axial piston pump with a variable-angle swashplate.

7. Naudic Incremental CVT (iCVT)

[The neutrality of this article is disputed. Please see the discussion on the talk page. Please do not remove this message until the dispute is resolved. (April 2012)]

This is a chain-driven system which is advertised at*[2] Although an iCVT works, it has the following weakness:

### High Frictional Losses

The variator pulley of an iCVT is choked using two small choking pulleys. Here one choking pulley is positioned on the tense side of the chain of the iCVT. Hence there is a considerable load on that choking pulley, the magnitude of which is proportional to the tension in its chain. Each choking pulley is pulled up by two chain segments, one chain segment to the left and one to the right of the choking pulley; here if the two chain segments are parallel to each other, then the load on the choking pulley is twice the tension in the chain. But since the two chain segments are most likely not parallel to each other during operations of an iCVT, it is estimated that the load on a choking pulley is between 1 to 1.8 times of the tension of its chain. Also, a choking pulley is very small so that its moment arm is very small. A larger moment arm reduces the force needed to rotate a pulley. For example, using a long wrench, which has a large moment arm, to open a nut requires less force than using a short wrench, which has a small moment arm. Assuming that the diameter of a choking pulley is twice the diameter of its shaft, which is a generous estimate, then the frictional resistance force at the outer diameter of a choking pulley is half the frictional resistance force at the shaft of a choking pulley.

### Shock and Durability

The transmission ratio of an iCVT has to be changed one increment within less than one full rotation of its variator pulley. Has to be changed one increment means that the transmission diameter of the variator pulley has to be changed from a diameter that has a circumferential length that is equal to an integer number of teeth to another diameter that has a circumferential length that is equal to an integer number of teeth; such as changing the transmission diameter of the variator pulley from a diameter that has a circumferential length of 7 teeth to a diameter that has a circumferential length of 8 teeth for example. This is because if the transmission diameter of the variator pulley does not have a circumferential length that is equal to an integer number of teeth, such as a circumferential length of 7½ teeth for example, improper engagement between the teeth of the variator pulley and its chain will occur. For example, imagine having a bicycle pulley with 7½ teeth; here improper engagement between the bicycle pulley and its chain will occur when the tooth behind the ½ tooth space is about to engage with its chain, since it is positioned a distance of ½ tooth too late relative to its chain.

Regarding the previous paragraph, the chain of an iCVT forms an open loop on its variator pulley that partially covers its variator pulley such that an open section, which is not covered by the chain, exist. This is similar to a sprocket of a bicycle where there is a section of the sprocket that is covered by its chain, and a section of the sprocket that is not covered by its chain. During one complete rotation, the toothed section of the variator pulley of an iCVT passes by the open section and re-engages with the chain. Here if the transmission diameter of the variator pulley does not represent an integer number of teeth, improper re-engagement between the teeth of the variator pulley and its chain will occur. Also, the transmission diameter of the variator pulley cannot be changed while the toothed section of the variator pulley is covering the entire open section of its chain loop. Since this is similar to where a plate is glued across the open section of a chain loop, which does not allow expansion or contraction of the chain loop as required for transmission diameter change of the variator pulley. Therefore the transmission diameter of the variator pulley has to be changed one increment during an interval where the variator pulley rotates from an initial position where a portion of the toothed section of the variator pulley is positioned at the open section of the chain loop but not covering the entire open section, to the final position where the toothed section of the variator pulley passes by the open section of the chain loop and is about to re-engage with the chain. Since it takes less than one full rotation to rotate the variator pulley from its initial position to its final position mentioned in the previous sentence, the transmission diameter of the variator pulley has to be changed one increment within less than one full rotation. In addition, as the transmission diameter is increased, the chain has to be pushed up the inclined surfaces of the pulley halves of the variator pulley, while the tension in the chain tends to pull the chain towards the opposite direction. Hence a large force, which is larger than the tension in the chain, is required to change the transmission diameter. Since the transmission ratio has to be changed within less than one full rotation of the variator pulley, a large force has to be applied on the pulley halves within a very short duration. If for example the variator pulley rotates at 3600 rpm, which is equivalent to 60 revolutions per second, then the force required to change the transmission ratio has to be applied within 1/60 seconds. This would be similar to hitting something with a hammer. Herefore, here significant shock loads are applied to the variator pulley during transmission ratio change that increases the transmission diameter. These shock loads my cause comfort problem for the driver of the vehicle using an iCVT. Also an iCVT has to be designed as to be able to resist these shock loads which would most likely increases the cost and weight of an iCVT.

### Torque Transfer Ability and Reliability

The teeth of the variator pulley of an iCVT are formed by pins that extend from one pulley half to the other pulley half and slide in the grooves of the pulley halves of the variator pulley. Here torque from the chain is transferred to the pins and then from the pins to the pulley halves. Since the pins are round and the grooves are curved, line contact between the pins and the grooves are used to transfer force from the pins to the grooves. The amount of force that can be transmitted between two parts depend on the contact area of the two parts. Since the contact areas between the pins and their grooves are very small, the amount of force that can be transmitted between them, and hence also the torque capacity of an iCVT, is limited.

Another possible problem with an iCVT is that the pins of the variator pulley can fall-out when they are not engaged with their chain. And wear of the pins and the grooves of the pulley halves can cause some serious performance and reliability problems.

8. Cone CVTs

A cone CVT varies the effective gear ratio using one or more conical rollers. The simplest type of cone CVT, the single-cone version, uses a wheel that moves along the slope of the cone, creating the variation between the narrow and wide diameters of the cone. The more sophisticated twin cone mesh system is also a type of cone CVT.[11][12] In a CVT with oscillating cones, the torque is transmitted via friction from a variable number of cones (according to the torque to be transmitted) to a central, barrel-shaped hub. The side surface of the hub is convex with a specific radius of curvature which is smaller than the concavity radius of the cones. In this way, there will be only one (theoretical) contact point between each cone and the hub at any time. A new CVT using this technology, the Warko, was presented in Berlin during the 6th International CTI Symposium of Innovative Automotive Transmissions, on 3-7 Dec. 2007. A particular characteristic of the Warko is the absence of a clutch: the engine is always connected to the wheels, and the rear drive is obtained by means of an epicyclic system in output.[13] This system, named “power split”,[14] allows the engine to have a “neutral gear”:[15] when the engine turns (connected to the sun gear of the epicyclic system), the variator (i.e., the planetary gears) will compensate for the engine rotation, so the outer ring gear (which provides output) remains stationary.

### Radial Roller CVT

The working principle of this CVT is similar to that of conventional oil compression engines, but, instead of compressing oil, common steel rollers are compressed.[18] The motion transmission between rollers and rotors is assisted by an adapted traction fluid, which ensures the proper friction between the surfaces and slows down wearing thereof. Unlike other systems, the radial rollers do not show a tangential speed variation (delta) along the contact lines in the rotors. From this, a greater mechanical efficiency and working life are claimed.

### Planetary CVT

In a Planetary CVT, the gear ratio is shifted by tilting the axis of spheres in a continuous fashion, to provide different contact radii, which, in turn, drive input and output discs. The system can have multiple “planets” to transfer torque through multiple fluid patches. One commercial application is the NuVinci Continuously Variable Transmission.

### SUMMARY OF THE INVENTION

It is a principle object of the present invention to provide a means for producing continuously variable angular velocity and mechanical advantage over a wide shift range with high torque capability and high efficiency from a fixed angular velocity input. It is a principle object of the present invention to provide a means for producing continuously variable angular velocity and mechanical advantage over a wide shift range using geared contacts for power transfer and Gear-Bearing technology in motion control with high efficiency. It is a principle object of the present invention to provide continuously variable speed and mechanical advantage over a wide shift range using a two-stage epicyclical planetary transmission in which the ground stage causes shifting by expanding and contracting the diameter of the segmented ground gear and displacing the ground stage planets to maintain geared contact with ground gear segments. It is a principle object of the present invention to provide a ground gear segment management system whereby a diameter of segmented ground gear is set, whereby gaps between said ground gear segments are cyclically eliminated and said ground gear segment curvature errors are cyclically corrected to produce the functional equivalent of a ground gear with a continuously variable diameter. It is a principle of the present invention to provide two-stage planet gear-bearings with variable displacement in the radial direction. It is a principle object of the present invention to provide equilibrium locking for motion control and efficiency. It is an object of the present invention to provide high torque and power density from a compact package. It is an option of the present invention to use construction methods and materials that are low cost and simple.

In accordance with the present invention, Segmented Ground Gear Transmissions (SGGT) are a type of continuously variable two-stage epicyclical transmission in which the input stage is a fixed epicyclical gear system, where the ground stage is an epicyclical gear system in which the ground ring diameter can be varied and where the planets in each stage are joined by universal joints to form two-stage planets, where the planet ground stages can displace radially to retain contact with ground gear segments while the diameter of the ground gear is varied to produce continuously variable angular velocity and mechanical advantage changes in the fixed epicyclical gear system output. Each Segmented Ground Gear Transmission comprising:
1. A fixed epicyclical gear system with input gear, multiple planet gears and an output gear.
2. A variable epicyclical gear system with a variable diameter idler roller, multiple variable displacement planet gears and a segmented ground gear system.
3. Universal joints connecting the planets to form two-stage planets in the stages rotate and orbit together at the same angular velocities, where torque can be transferred between stages and where the ground stages can be displaced with respect to the input stages.

Segmented ground gear systems are the functional equivalent of a ring gear that can expand or contract over a range of diameters, while maintaining a constant diametral pitch and adding or subtracting teeth as required. Segmented ground gear systems divide a ground gear into twice as many segments as there are planets, half occupied by orbiting and rotating planets and half free. The segments and planets are moved radially to a ground ring diameter of choice, changing the gaps between segments in the process. The free segments move to close the gaps in advance of planet arrival, while the occupied segments remain stationary and react to planet torque. When the planets arrive, the free segments stop and occupy the planets, while the newly freed segments move to close the new set of gaps and the cycle repeats. The occupied segments twist slightly to maintain normal contact with the planets, thereby correcting segment curvature errors caused by radially displacing the segments. In one complete orbit, each planet engages the total teeth in the segments plus the equivalent number of teeth represented by the gap total. That is, in one complete planet orbit, some segment teeth are engaged more than once and we have the equivalent of an expanded ground gear with teeth added. We add a radially expanding and contracting shifter which can push the planets and segments radially outwards or allow spring return to push the planets and segments radially inwards and we have the ground stage of a two-stage planetary transmission.

We add a fixed planetary stage with input drive gear and connect the planet gears with universal joint mechanisms to form a two-stage planet gears and a two-stage epicyclical planetary transmission in which the ground stage is continuously variable.

We can, now, vary the ground ring diameter and, thereby, change the planet orbit and rotation angular velocities which, in turn, change the angular velocity and mechanical advantage of the fixed planetary stage output gear and where the changes in angular velocity and mechanical advantage at the fixed planetary stage output gear are continuously variable.

At this point we have a two-stage epicyclical planetary gear system transmission with continuously variable output angular velocity and mechanical advantage from a fixed angular velocity input.

But, the above overview will benefit from additional detail.
1. Gear-Bearing technology must be applied throughout the system to ensure proper gear mesh, motion control and anti-friction, efficient, rolling contacts throughout.
2. The shift range can be constructed to form a maximum reverse to stop to maximum forward continuously variable range. The maximum reverse to stop and stop to maximum forward sections of the shift range can be apportioned as desired.
3. The range of angular velocities and mechanical advantages at the output is broad, but the output angular velocities are typically lower than the input angular velocity.
4. A fixed gear ratio speeder can be added to the output to increase the angular velocity for the entire shift range by a fixed multiplication factor for applications that require high angular velocities. This will also result in lower mechanical advantage according to Conservation of Energy.
5. The Segmented Ground Gear Transmission concept has many contacts under load, especially when a fixed gear ratio speeder is included, so high overall efficiency is preserved by using anti-friction rolling contacts exclusively, both for power transfer and motion control. The extraordinary efficiency of modern gear technology and the extraordinary capabilities of modern lubrication systems are also helpful.

### BRIEF DESCRIPTION OF THE DRAWINGS

A more complete appreciation of the invention and many of its attendant advantages will be readily appreciated as the same becomes better understood by reference to the following detailed description when considered in connection with accompanying drawings wherein:

FIG. 1 introduces the Gap Management CVT concept using a side section view with the CVT shifted to a stop or infinite mechanical advantage position.

FIG. 2 continues the side section view introduction by showing the CVT shifted to a maximum forward speed position in contrast to the stop or infinite mechanical advantage position of FIG. 1.

FIG. 3 illustrates a method for systematically closing the gaps between the ground stage ring segments so as to enable continues orbiting and rotation of the planets in the case where the gap size is zero.

FIG. 4 illustrates the case where the gap size between ground stage ring segments is greater than zero and shows the movements taken by the ground ring system to systematically close these gaps to enable continuous rotation and orbit of the planets and continuous input/output of the CVT.

FIG. 5 illustrates a top cut-away view of a ground ring section which can move radially while being constrained against the CVT input/output torque.

FIG. 6 illustrates a cross section view of a ground ring section which can move radially while being constrained against the CVT input/output torque.

FIG. 7 shows a gear-bearing component which enables each ground ring gear-bearing section to move radially and resist and withstand high output torque and twist.

FIG. 8 shows a cross-section view, along the CVT radius, of a ground ring gear-bearing section attached to the inner moveable ground ring gear.

FIG. 9 shows a cross-section view, along the Geared CVT radius, of a ground ring gear-bearing section, attached to the outer moveable ground ring gear.

FIG. 10 shows a top, cut-away view of a ground ring gear-bearing section in the presence of the inner and outer moveable ground ring gears. This view applies when the ground ring gear-bearing section is attached to either the inner or the outer moveable ground ring gears.

FIG. 11 shows two (2) stage pinion gears coupling the Inner Moveable Ring Gear to a fixed internal ground gear and two (2) stage gears coupling the Outer Moveable Ring Gear to a fixed external ground gear.

FIGS. 12A,12B, 12C and 12D, collectively, show how the two stage gears equilibrium lock the inner moveable ring gear to a fixed, Internal ground gear and the outer moveable ring gear to a fixed, external ground gear to prevent back drive with power off. FIG. 12A and FIG. 12B illustrate equilibrium lock with a tooth of one stage directly above a tooth of the other stage. FIG. 12A shows the situation immediately before equilibrium lock. FIG. 12B shows the situation immediately after equilibrium lock. FIG. 12C and FIG. 12D illustrate equilibrium lock with a tooth of one stage directly above the midpoint between two teeth of the other stage.

FIG. 13 illustrates the shift method (cross-section view)

FIG. 14 illustrates the motion control system used in the bottom half of the shift system (cross-section view).

FIG. 15 illustrates the shift radial expansion Interface. FIG. 15A shows a cross-section view to illustrate how the interface works and FIG. 15B shows the flexure pattern that supports radial expansion.

FIG. 16 illustrates a cross-section view of a gear-bearing ground planet stage to show how top and bottom rollers can contact corresponding roll races on the ground gear sections to control the radial position of the sections while simultaneously maintaining optimum gear meshing between the planets and the sections.

FIGS. 17A, 17B and 17C together illustrate the contact surfaces of a Ground Gear Section to include roll contacts between planets and sections, gear tooth contacts between planets and sections and contacts between sections. FIG. 17A shows a ground gear section top view. FIG. 17B shows a type 1 ground gear section face view. FIG. 17C shows a type 2 ground gear section face view.

FIG. 18 shows the curvature correction required when ground gear sections are displaced radially outward or inward.

FIGS. 19A, 19B and 19C together show how a ground gear section corrects curvature by rotating as a planet passes through the section. FIG. 19A shows section rotation when a contacting planet is at one end of a section. FIG. 19B shows section rotation when a contacting planet is in the center of a section. FIG. 19C shows section rotation when a contacting planet is at the other end of a section.

FIG. 20 illustrates how adjacent Ground Gear Sections remain in contact with each under maximum separation gap conditions.

FIG. 21 illustrates where adjacent Ground Gear Sections contact under zero gap conditions and where near contact, non-interferrence, conditions are maintained.

FIG. 22 illustrates how Ground Gear Sections contact along mirror image cylindrical surfaces, thereby enabling contact to be maintained between the sections as they mutually rotate in response to a planet passing from one section to another.

FIG. 23 illustrates a two-stage planet cross-section view with zero displacement between the stages (orientation 1). This view shows detail on the planet internal gear bearings and coupling shaft and their interfaces.

FIG. 24 illustrates a cross-section view of the two-stage planet of FIG. 23 (at orientation 2). This view shows detail on the planet internal gear bearings and coupling shaft and their interfaces. Orientations 1 and 2 are orthogonal to each other.

FIG. 25 illustrates the input/output stage of a two-stage planet from a top view. The relative positions between the coupling shaft, the gear bearings and the planet input/output stage planet are shown. The planet is oriented with a zero angle of rotation and zero displacement between the two planet stages.

FIG. 26 illustrates the ground stage of the two-stage planet from a bottom-up view. The relative positions between the coupling shaft, the gear-bearings and the planet ground stage planet are shown. The planet is oriented with a zero angle of rotation and zero displacement between the two planet stages.

FIG. 27 illustrates the input/output stage top view as per FIG. 25 except that the ground stage planet is displaced outward (+X) with respect to the fixed radial position input/output stage planet. The relative positions between the coupling shaft, the gear bearings and the input/output stage planet are shown. These are altered from the zero displacement case.

FIG. 28 illustrates the ground stage planet bottom-up view as per FIG. 26, except the ground stage planet is displaced outward (+X) with respect to the fixed radial position input/output stage planet. The relative positions between the coupling shaft, the gear-bearings and the input/output planet stage are shown. These are altered from the zero displacement case.

FIG. 29 illustrates the input/output stage planet top view as per FIG. 27 except that the two-stage planet has been rotated 90 deg.

FIG. 30 illustrates the ground stage planet bottom-up view as per FIG. 28 except that the two-stage planet has been rotated 90 deg.

FIG. 31 illustrates the relative positions of the coupling shaft, the gear bearings and the two-stage planet with zero displacement between the planet stages and with a rotation angle of zero deg.

FIG. 32 illustrates the relative positions of the moving parts as per FIG. 31 with the ground stage planet displaced outward (+X) from the input/output stage planet with a planet rotation angle of zero deg.

FIG. 33 illustrates the relative positions of the moving parts as per FIG. 32 except the two-stage planet rotation angle is 45 deg.

FIG. 34 illustrates the relative positions of the moving parts as per FIG. 32 except the two-stage planet rotation angle is 90 deg.

FIG. 35 illustrates the relative positions of the moving parts as per FIG. 32 except the two-stage planet rotation angle is 135 deg.

FIG. 36 shows a cross-section view of a speeder apparatus to speed up the shifted output by a fixed amount across the entire shift range. This provides an adjusted over-drive capability for vehicles, such as automobiles, where such an over-drive speed is useful.

### DETAILED DESCRIPTION OF PREFERRED EMBODIMENT

In accordance with the present invention, a Segmented Ground Gear Transmission (SGGT) is a type of two-stage epicyclical planetary transmission which includes a fixed input/output stage and a continuously variable ground stage which enables the output angular velocity to be continuously varied while the input angular velocity remains constant. The input/output stage includes a geared input shaft, a cluster of geared input/output stage planets and an output ring. The input/output stage planets mesh with both the geared input shaft and the output ring. The ground stage includes a cluster of ground stage planets, a ground ring system and a shift system. The ground stage planets mesh with the ground ring system and interface with the shift system by means of a shift interface roller. The shift interface roller is variable in diameter and is capable of displacing the ground stage planets radially. The ground ring system is sectioned so the sections can be displaced radially with the radial displacement of the ground stage planets. The ground stage planets and the input/output stage planets are coupled to each other by a power transfer shaft whereby the ground stage planets can be radially displaced with respect to the input/output stage planets while the input/output stage planets and the ground stage planets remain constrained to orbit and rotate at shared angular velocities. Shifting is accomplished by the shift system roller displacing the ground stage planets and the ground ring sections radially. This changes the planet system orbit and rotation angular velocities, with the output ring angular velocity changed as well. Shifting can be performed while the SGGT is in operation in real time. Displacing the ring sections radially outward opens gaps between the sections and introduces curvature errors in the ground ring sections. To overcome the problem of the gaps, twice as many sections as planets are used. So, one half the sections are free to move under no-load conditions while the other half are stationary while torque from the planet ground stages is reacted against the stationary sections. (This is designed to minimize energy loss during gap management since energy use requires moving force or torque.) The free ground ring sections rotate to close the gaps so when the planets run out of space on the stationary sections, they acquire new space on the repositioned sections and the process can continue for multiple, continuous rotations.

Curvature corrections are performed by the individual ground sections rotating under contact with the planet ground stages. The correction angles are small and the section rotation is slight. The SGGT typically provides a relatively low angular velocity output with a wide shift range from a relatively high angular velocity input. For applications like automobiles where a high cruising speed is required, a fixed ratio speeder can be added between the SGGT output and the final dive. The SGGT concept has numerous gear contacts and parts so efficiency, simplicity and compactness are maintained by careful design attention to detail.

### 1. The Segmented Ground Gear Transmission (SGGT) System Overview

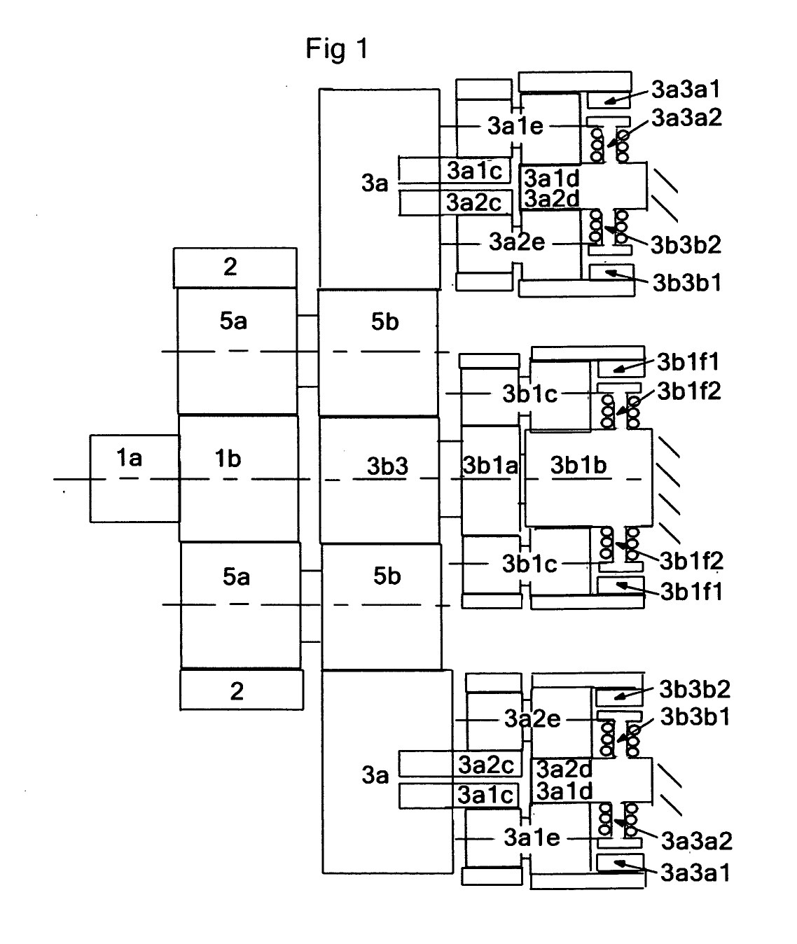

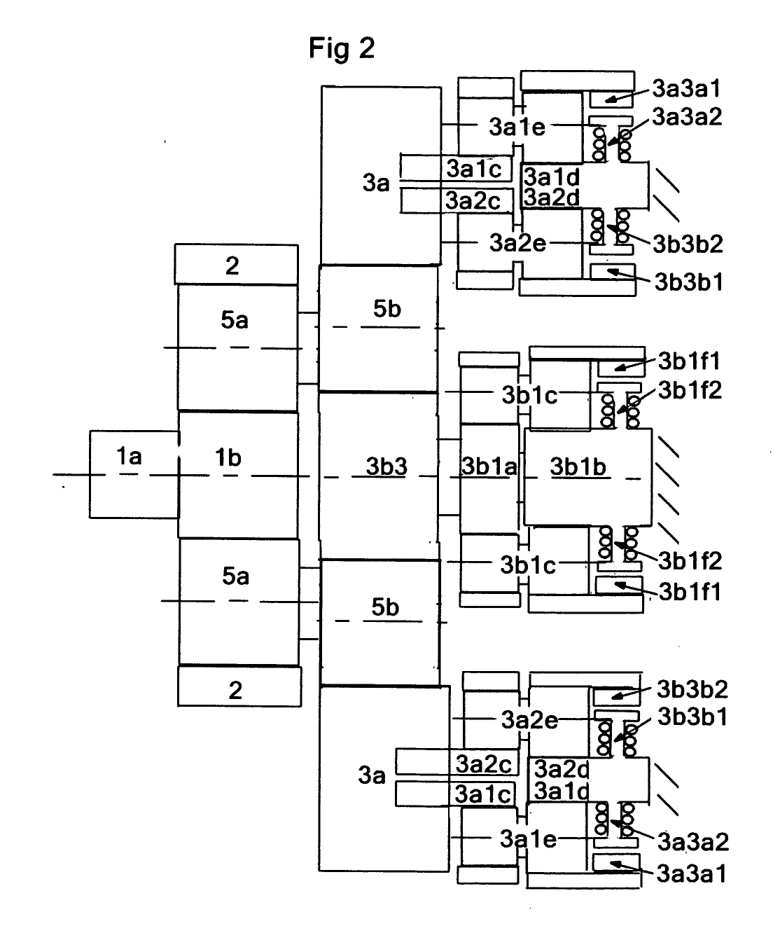

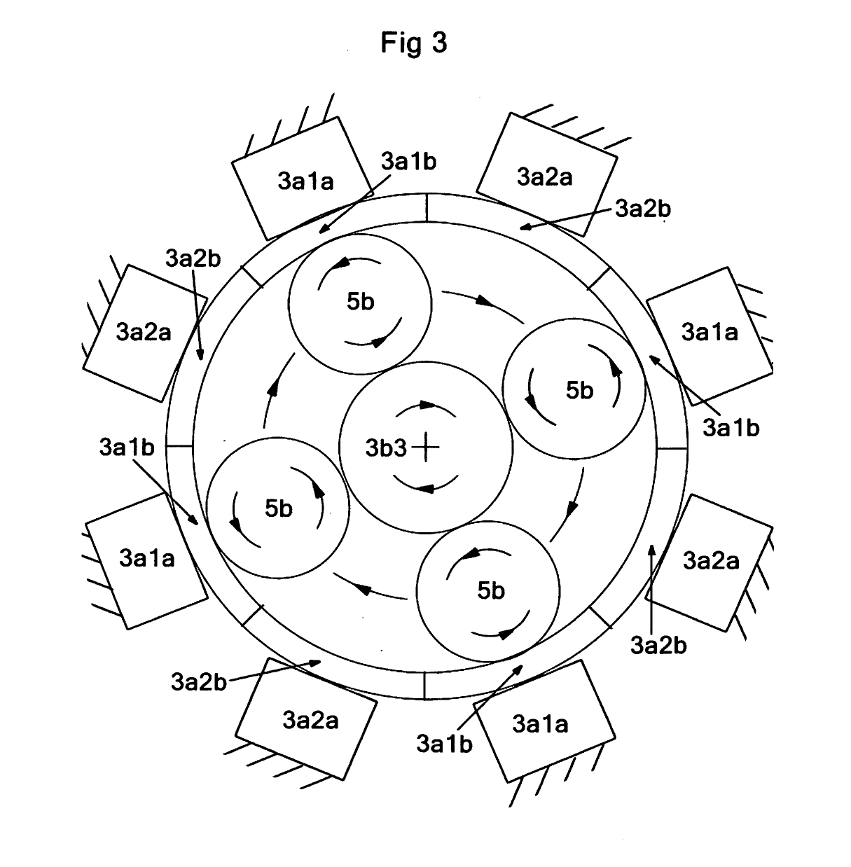

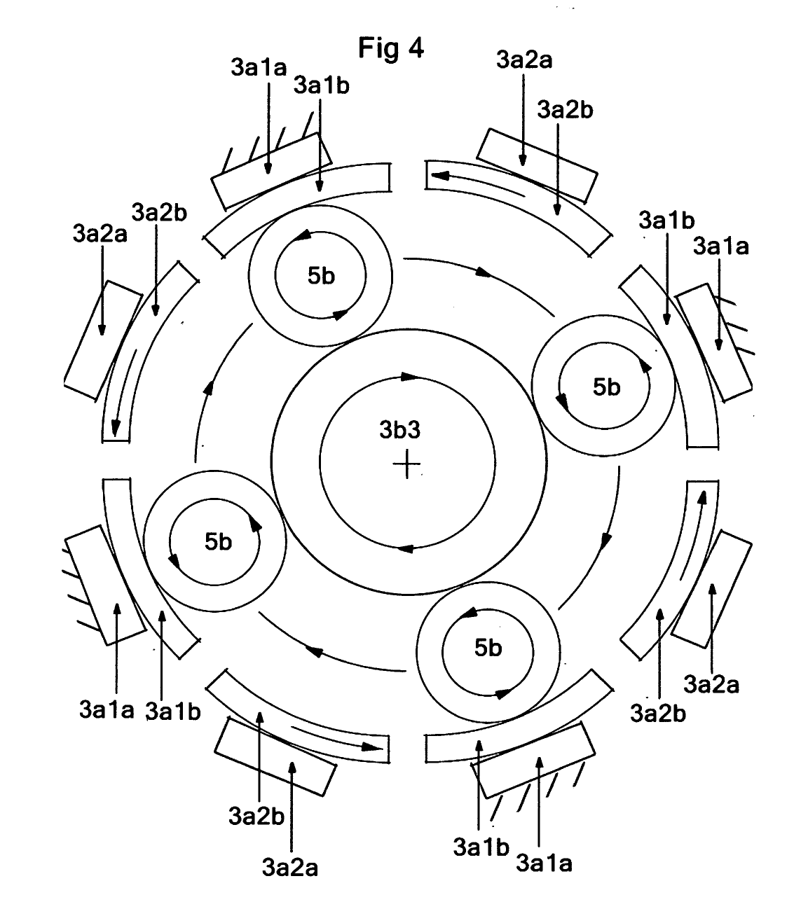

The SGGT System is shown in FIGS. 1, 2, 3 and 4. In the functional schematic view of FIG. 1 we see the input/output stage comprising a geared input shaft (shaft labeled 1a and input gear labeled 1b), four input/output planets (labeled 5a) and an output ring (labeled 2). We see the ground stage comprising ground ring segments (labeled 3a), four ground stage planets (labeled 5b), a shift interface roller (labeled 3b3), a system to support and manage the ground ring segments and a system to support and manage the shift system. FIG. 1 shows the SGGT with a mechanical advantage of infinity where the planets (labeled 5a and 5b) are the same diameter and are positioned directly above each other. Under these conditions, the output ring (labeled 2) does not move regardless of input shaft (labeled 1a) angular velocity. A mechanical advantage of less than infinity is shown in FIG. 2, where the same functional schematic view is shown except the ground stage planets (labeled 5b) are displaced radially outwards by the shift interface roller (labeled 3b) and the ground ring segments (labeled 3a) have complied radially to accommodate the displaced ground stage planets. In FIGS. 3 and 4 we see a bottom up functional schematic view of the ground ring segments (labeled 3a in FIGS. 1 and 2), the ground stage planets (labeled 5b) and the shift interface roller (labeled 3b3). The ground stage planets (labeled 5b) are rotating counter clockwise and orbiting clockwise. The shift interface roller (labeled 3b3) is rotating clockwise. In this bottom up view, additional detail emerges. We see there are four (4) ground stage planets (labeled 5a) and eight ground ring segments operating in two groups of four each. The four ground ring segments in one group are labeled 3a1a and 3a1b and the four ground ring segments in the other group are labeled 3a2a and 3a2b. These labels identify the components (3a1b and 3a2b) within the ground ring segments (labeled 3a) that displace radially outwards and inwards because of shifting and the components (3a1a and 3a2a) that rotate to close gaps, but do not displace radially. FIG. 3 shows the condition with zero displacement and infinite mechanical advantage. FIG. 4 shows the condition with maximum displacement and minimum mechanical advantage (we estimate 14 to 1). The FIG. 3 condition shows the ground ring segments (labeled 3a1a1 and 3a2a1) touching each other with no gaps between them. FIG. 4 shows operations under displaced conditions with one set of stationary ring section components (3a1a and 3a1b) reacting torque from the ground stage planets while the other set of ground ring section components (3a2a and 3a2b) rotate to close the gaps. The rotation to close the gaps is counter clockwise because the planets are orbiting clockwise. The mechanical advantage can be varied continuously between 14 to 1 and infinity to 1.

2. The Ground Stage

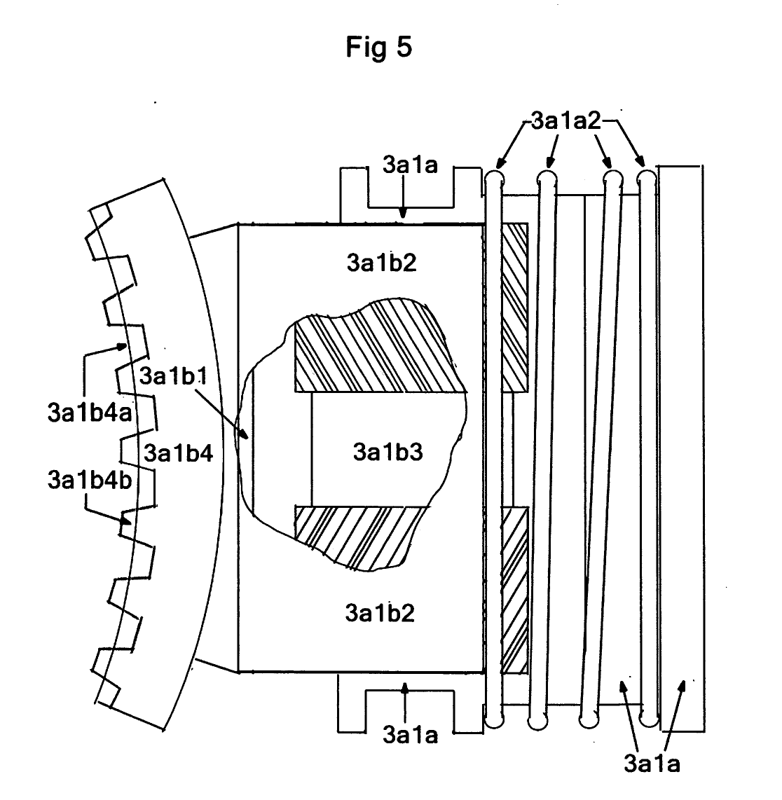

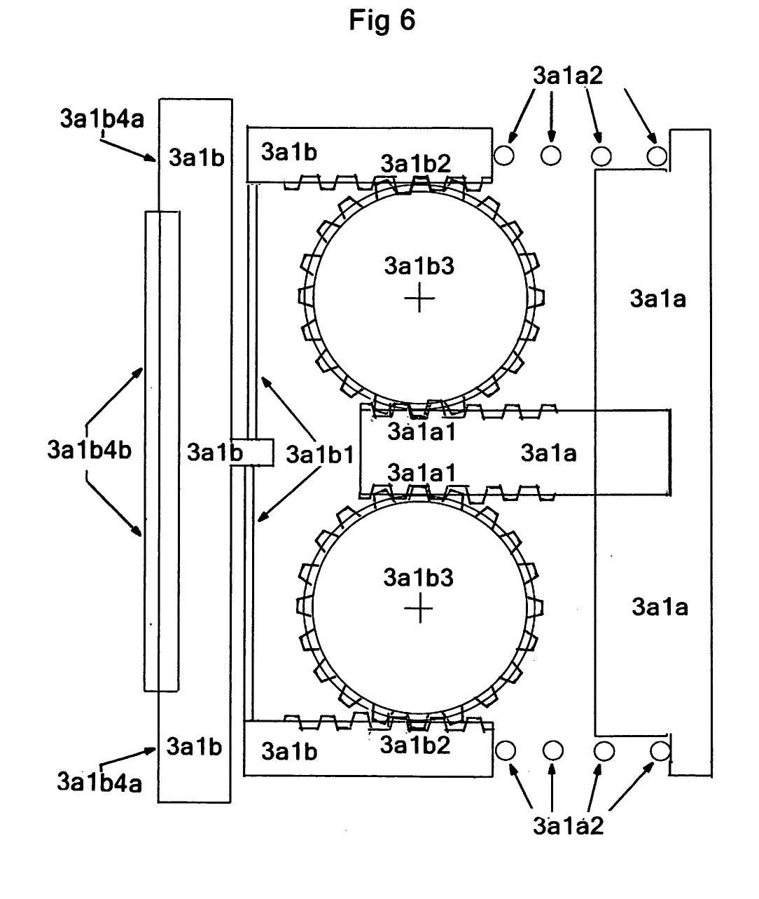

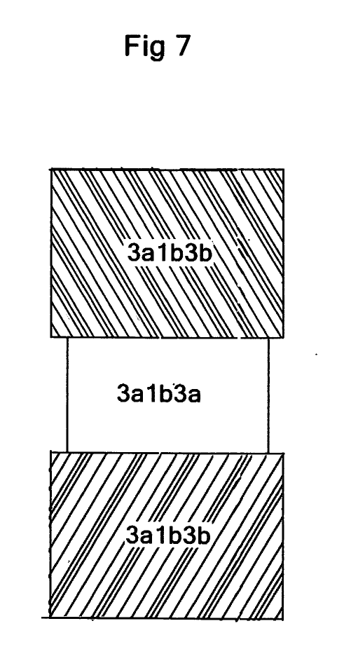

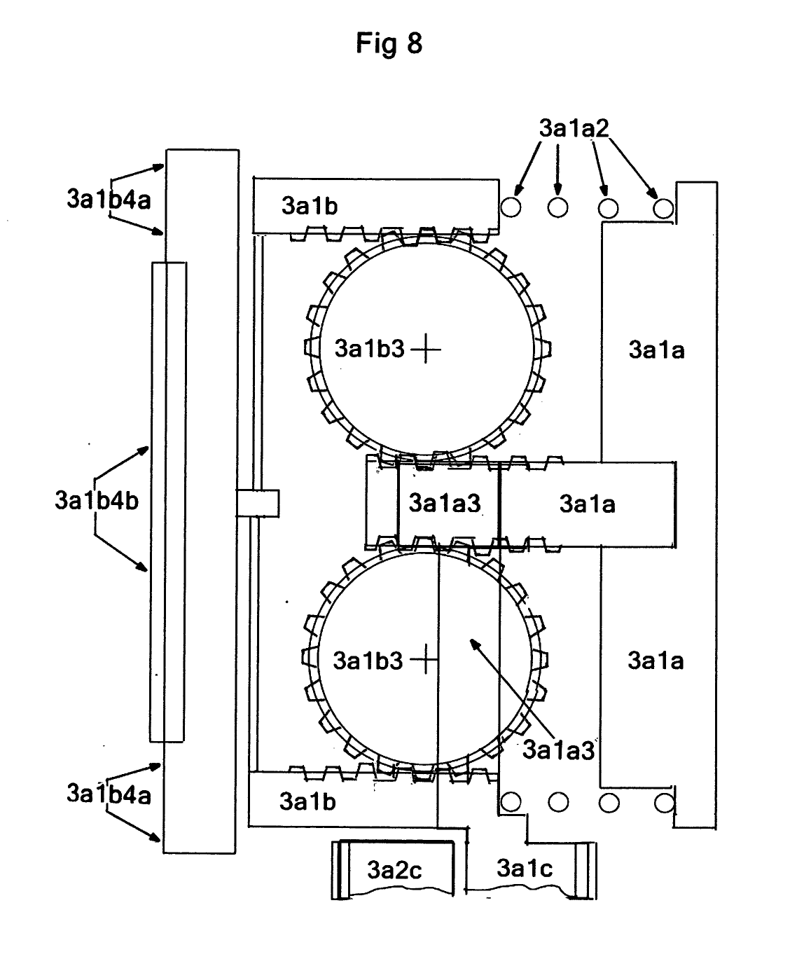

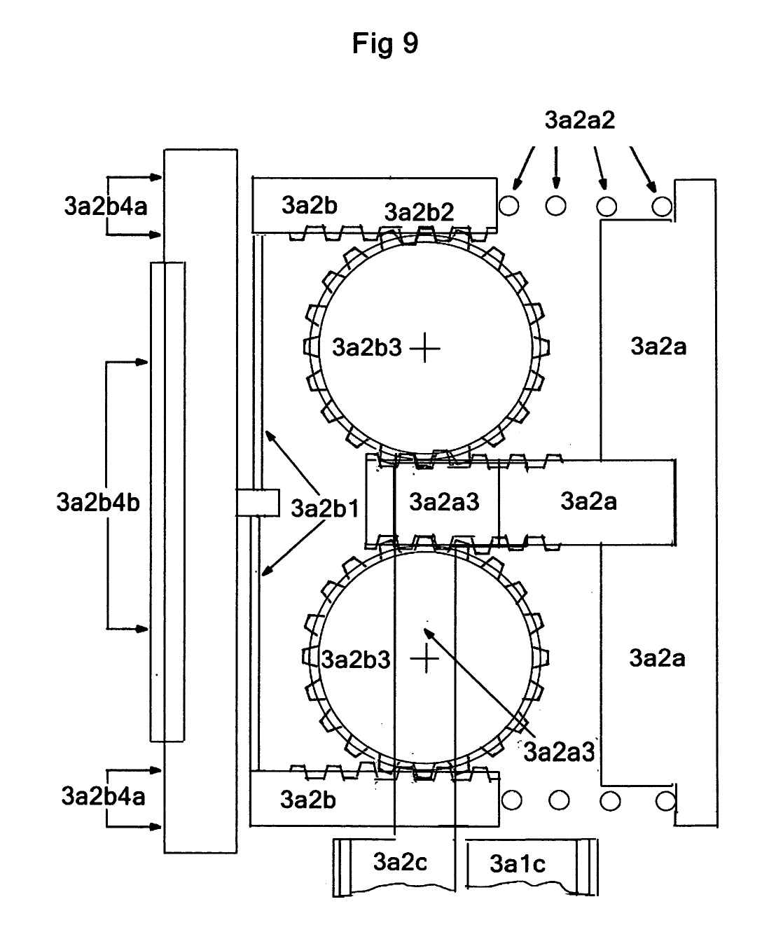

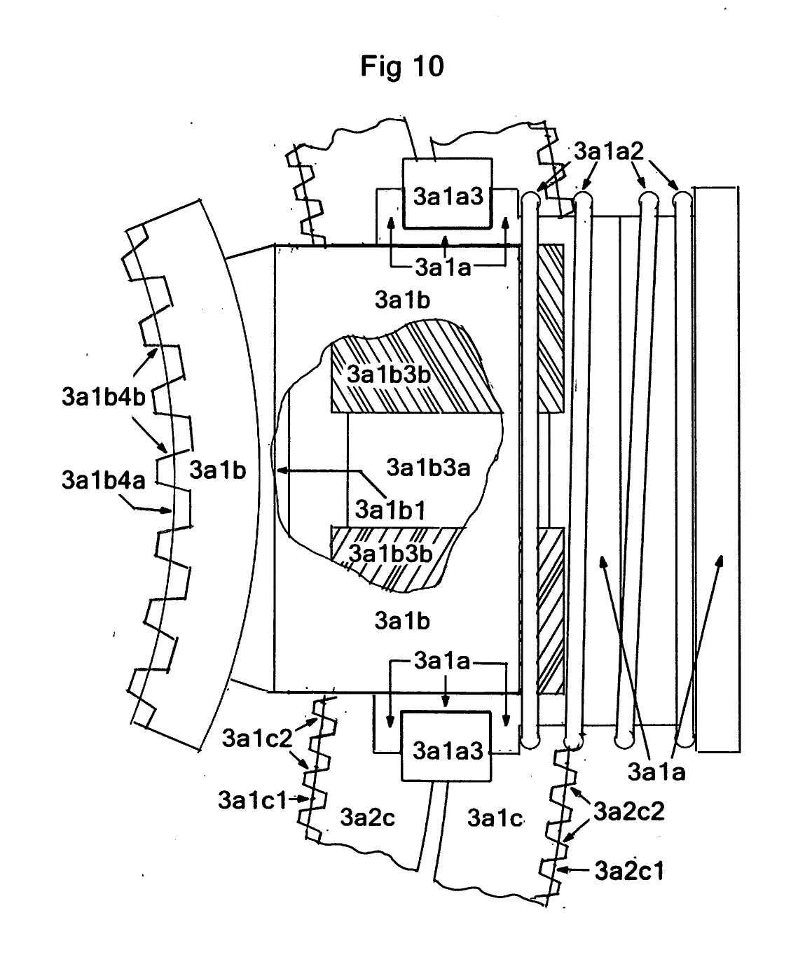

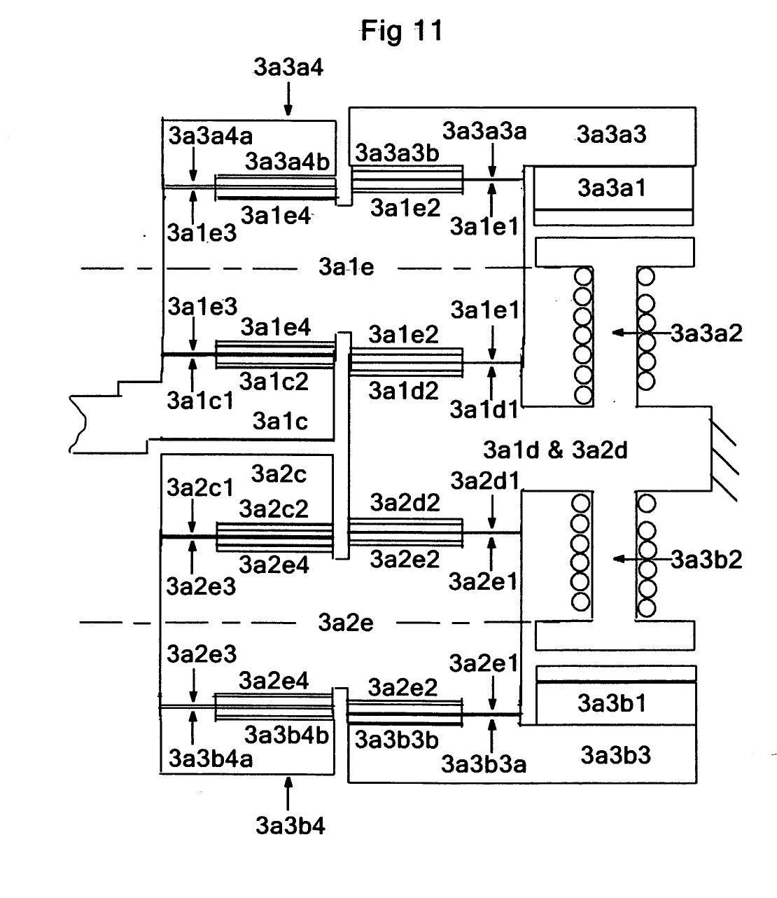

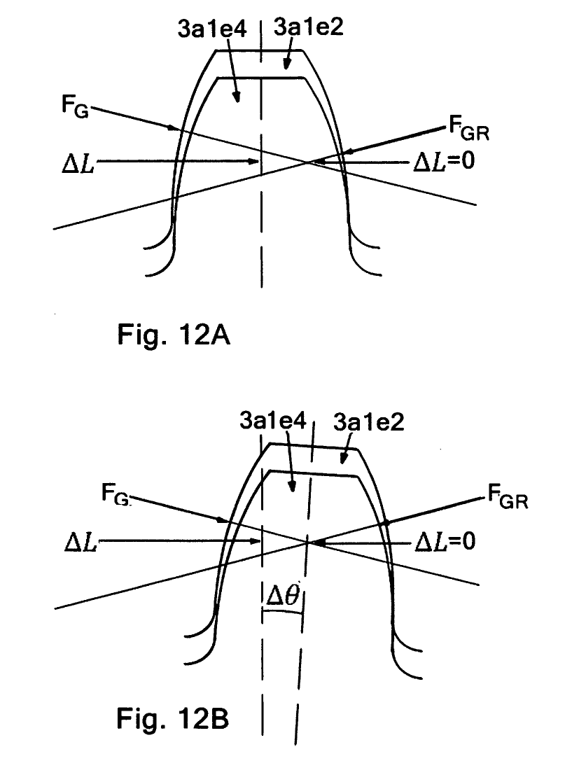

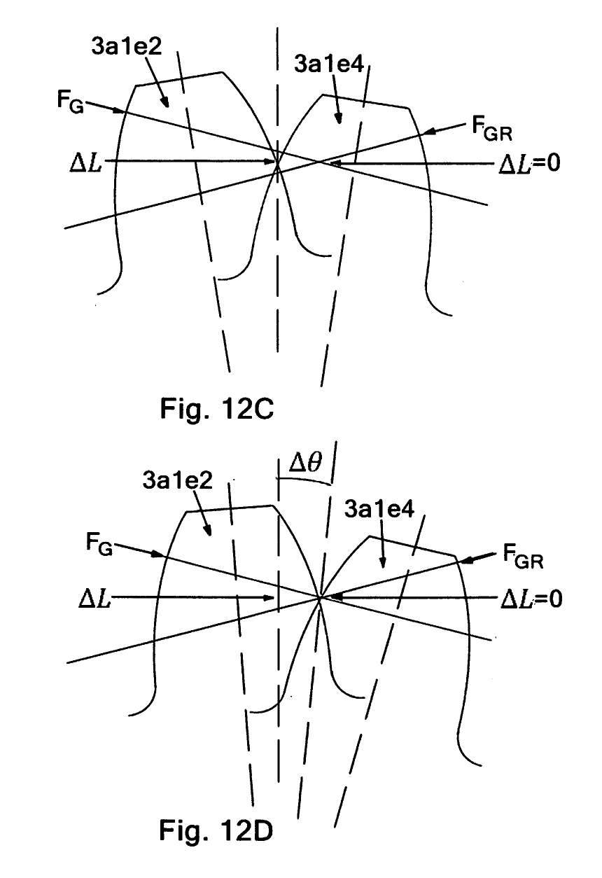

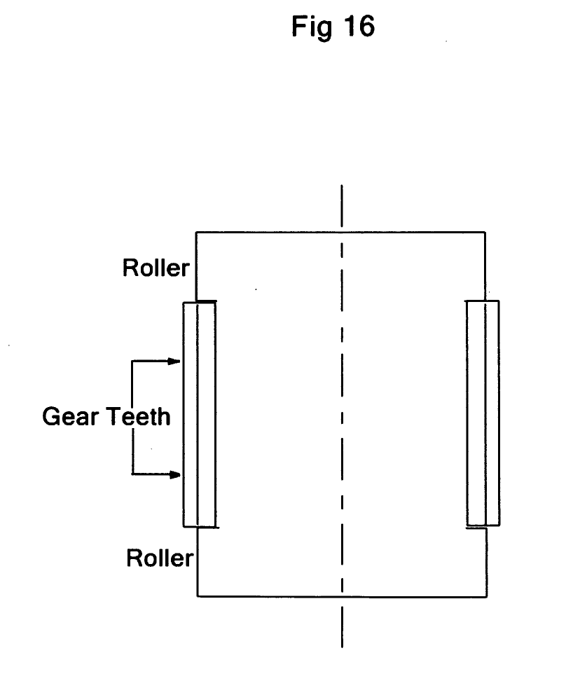

The ground stage is vital to the SGGT concept so we will now examine it in more detail. We will proceed by examining the ground ring segments containing the 3a1a and 3a1b components with the understanding that this applies to the ground ring segments containing the 3a2a and 3a2b components as well. We will first work our way through the ground ring segments and then turn our attention to the shift system. We will work our way through the ground ring segments, starting with contact with the ground stage planets (labeled 5b) and finishing with mechanical ground.
a. We begin with the contact between the gear teeth of the ground stage planets and the gear teeth of the ground ring segments. We need a proper gear mesh while the segments are being pushed apart or spring returning radially so we use the Gear-Bearing concept [1][2][3][4]. The Gear-Bearing concept (FIG. 16) is constructed with a roller and gear co-axial in a single gear-bearing structure with the roller diameter set equal to the gear pitch diameter. The example in FIG. 16 is for an external gear and roller, but the same principle applies for an internal gear and roller race as used in the ground ring segments (FIGS. 5 and 6). Thus, a gear-bearing planet can contact and force an internal gear-bearing section radially outwards with roller to roller bearing race contacts while positioning the gear teeth of the ground stage planet and the gear teeth of the ground ring segments for efficient mesh operation. The roller to roller bearing race contact and the gear teeth contact velocities are equal so there are insignificant sliding losses and gear-bearing operation is very efficient. For added stability against tipping during planet to ground ring segments, rollers or roller bearing races are positioned above and below the gear teeth. In FIG. 16 we see the rollers (labeled rollers) and the gear teeth (labeled gear teeth). In FIGS. 5 and 6 we see more detail on the contact between the planet ground stages (labeled 5b) and the 3a1b components of the ground ring segments. We see a roller bearing race contact (labeled 3a1b4a) and internal gear teeth (labeled 3a1b4b) where the diameter of the roller bearing race and the pitch diameter of the internal gear teeth match and are co-axial. In FIG. 6 we see the roller bearing races (labeled 3a1b4a) above and below the gear teeth (labeled 3a1b4b).
b. The internal gear-bearing ground ring sections must be able to move radially in response the planet ground stages while maintaining contact and reacting torque generated by the planet ground-stages. To enable component 3a1b to move radially with respect to component 3a1a, gear-bearings (labeled 3a1b3) are used to couple 3a1b to 3a1a, with a spring return (labeled 3a1a2) pushing 3a1b away from 3a1a. Thus, component 3a1b can roll with respect to component 3a1a while maintaining contact with the planet ground stages because of the return spring. The coupling gear-bearings (labeled 3a1b3 in FIG. 6) are examined in more detail in FIG. 7 where we see they are configured with a center section roller (labeled 3a1b3a) and two end sections with opposite twist helical gears (labeled 3a1b3b). These opposite twist helical gears enable the coupling system to oppose and withstand large torques and still roll back and forth efficiently with rolling friction. The combination of gear teeth and rollers also keeps the gear-bearings (3a1b3), component 3a1a and component 3a1b properly positioned with respect to each other and without the coupling gear-bearings wandering out of position. The coupling gear-bearings must mate and mesh with their linear gear-bearing counter-parts (labeled 3a1a1 in component 3a1a and 3a1b2 in component 3a1b).
c. The components 3a1a must be selectively coupled to mechanical ground and moved to remove the gaps between adjacent ground sections on command. We will now discuss how this is accomplished. We first group the eight ground ring sections into two groups and attach each group to a dedicated moveable ground ring so when that moveable ground ring moves, four ground ring sections move with it and all four gaps caused by shifting are closed simultaneously. The remaining four moveable ground ring sections are attached to their own dedicated moveable ground ring and that moveable ground ring can be mechanically grounded while the other moveable ground ring is in motion and vice versa. With this concept, speed and direction of gap management can be changed on command. In FIG. 8 we see an outer moveable ground ring (labeled 3a1c) and an inner moveable ground ring (labeled 3a2c). We see the four 3a1a components each attached to the outer moveable ground ring by an attachment structure (labeled 3a1a3). In FIG. 9 we see the inner moveable ground ring (labeled 3a2c) and we see the four 3a2a components each attached to the inner moveable ground ring by an attachment structure (labeled 3a2a3). In FIG. 10 we see that two attachment structures (labeled 3a1a3) are used to attach each component 3a1a to moveable ground ring 3a1c. Similarly, two attachment structures (labeled 3a2a3) are used to attach each component 3a2a to moveable ground ring 3a2c.
d. We will now examine how the moveable ground rings work to provide a hard connection to mechanical ground in some circumstances and to provide a means of closing gaps between ground ring segments in other cases. In FIG. 11 we see that outer moveable ground ring (labeled 3a1c) is coupled to fixed outer ground ring (labeled 3a1d) by multiple planets (each labeled 3a1e) and inner moveable ground ring (labeled 3a2c) is coupled to fixed inner ground ring (labeled 3a2d) by multiple planets (each labeled 3a2e). The fixed ground rings and the moveable ground rings are co-axial with the SGGT center. Thus this moveable ground ring can rotate continuously about the SGGT center and the planets (3a1e) will rotate, orbit and recirculate in support. The movement of the outer moveable ground ring is driven by an electric motor driving planets (labeled 3a1e) through a geared ring (labeled 3a3a3). This causes the two stage planets (3a1e) to rotate and orbit about the SGGT center so as to react torque against fixed ground ring (3a1d) and apply drive torque to moveable ground ring (3a1c) with mechanical advantage. The two stage planets (3a1e) are shown in gear-bearing [1][2][3][4] form as are the fixed ground ring (3a1d), moveable ground ring (3a1c) and idler ring (3a3a4). The gear-bearings used can be as simple as straight spur gears over a roller or roller bearing race as the case may be. The electric motor driving the moveable ground ring (3a1c) uses a series of fixed electromagnetic poles (labeled 3a3a2) which circle the center of the SGGT to operate on the permanent magnet poles (labeled 3a3a1) on ring (3a3a3). The permanent magnet poles alternate between positive and negative poles facing the electromagnetic poles and the electric motor operates according to typical electric motor practice and art. In similar manner, the inner moveable ground ring (labeled 3a2c) is coupled to fixed inner ground ring (labeled 3a2d) by multiple two stage planets (each labeled 3a2e). Again, the fixed ground ring (3a2d) and the moveable ground ring (3a2c) are co-axial with the SGGT center. Thus, this moveable ground ring can rotate continuously about the SGGT center and the planets (3a2e) will rotate, orbit and recirculate in support. The movement of the inner moveable ground ring is driven by an electric motor driving planets (3a2e) through a geared ring (labeled 3a3b3) so as to react torque against fixed ground ring (3a2d) and apply drive torque to moveable ground ring (3a2c) with mechanical advantage. The two stage planets (3a2e) are shown in gear-bearing form as are the fixed ground ring (3a2d), moveable ground ring (3a2c) and idler ring (3a3b4). The gear-bearings used could be as simple as straight spur gears over a roller or roller bearing race as the case may be. The electric motor driving the moveable ground ring (3a2c) uses a series of fixed electromagnetic poles (labeled 3a3b2) which circle the center of the SGGT to operate on the permanent magnet poles (labeled 3a3b1) on ring (3a3b3). The permanent magnet poles alternate between positive and negative poles facing the electromagnetic poles and the electric motor operates according to typical electric motor practice and art. The moveable ground rings (3a1c and 3a2c) can operate independently or in synchronized coordination as required.
e. We will now describe a method by which the two stage planets can lock a moveable ground to a fixed ground with electric power off, but still function to move the moveable ground ring with electric power on (FIGS. 12A and 12B) [5]. In FIG. 12A we have a two stage planet being forced backwards by a moveable ground ring with a force (labeled F_{G}) against a fixed ground with a reaction force (labeled F_{GR}) with the initial planet rotation angle of zero deg. These opposing contact forces will each act along the line of action of their respective gear stages. Because the two-stage planets have slightly different gear diameters, the opposing forces are slightly displaced by a distance ΔL which results in a torque on the planet. This torque turns the planet as per FIG. 12B. As the planet turns (counterclockwise in this case), the F_{G} contact moves towards the tip of its tooth tip, while the F_{GR} contact moves towards the root of its tooth. At angle of turn (labeled Δθ in FIG. 12B), ΔL goes to zero and the planet ceases to turn. It locks up and no amount of added force at F_{G} and F_{GR} will change this until the point of failure is reached for the tooth structure. This roller locking concept works when the tooth working depths of the two stages overlap and the opposing back-drive forces are on the same side of the gear axis of rotation, with the motor drive forces operating on the opposite side. When the tooth working depths do not overlap (one gear is significantly smaller than the other, ΔL varies between a maximum and minimum value during back-drive, but never goes to zero and never locks up to prevent back drive. FIGS. 12A and 12B apply to the case where moveable ground ring 3a1c is being passively locked against power off back-drive, but the same results are obtained moveable ground ring 3a2c is being locked against power-off back drive by two-stage planets 3a2e as per FIG. 11.

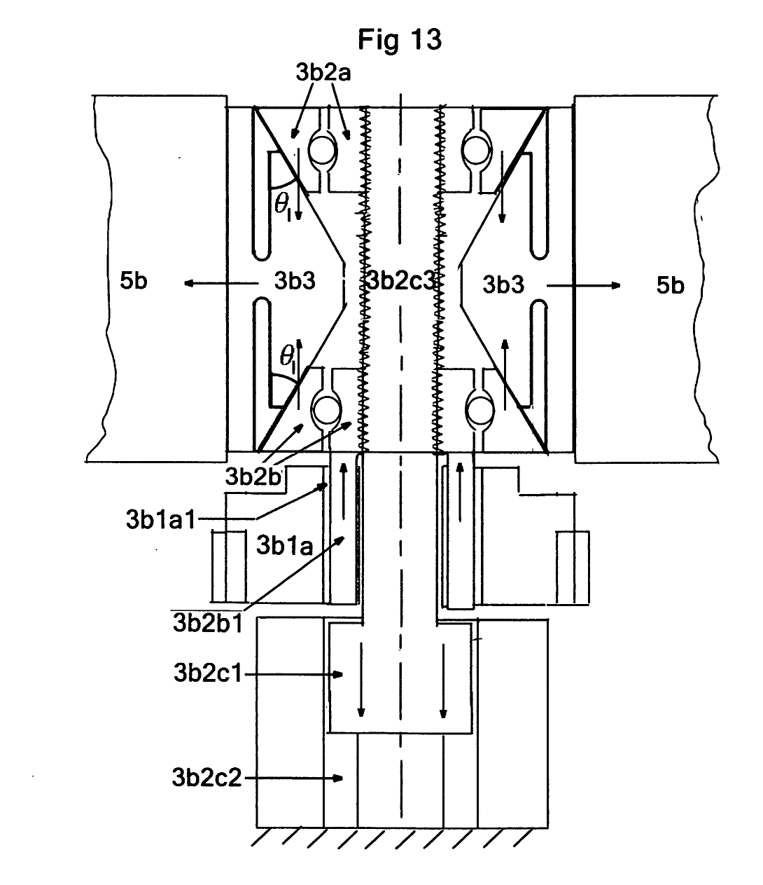

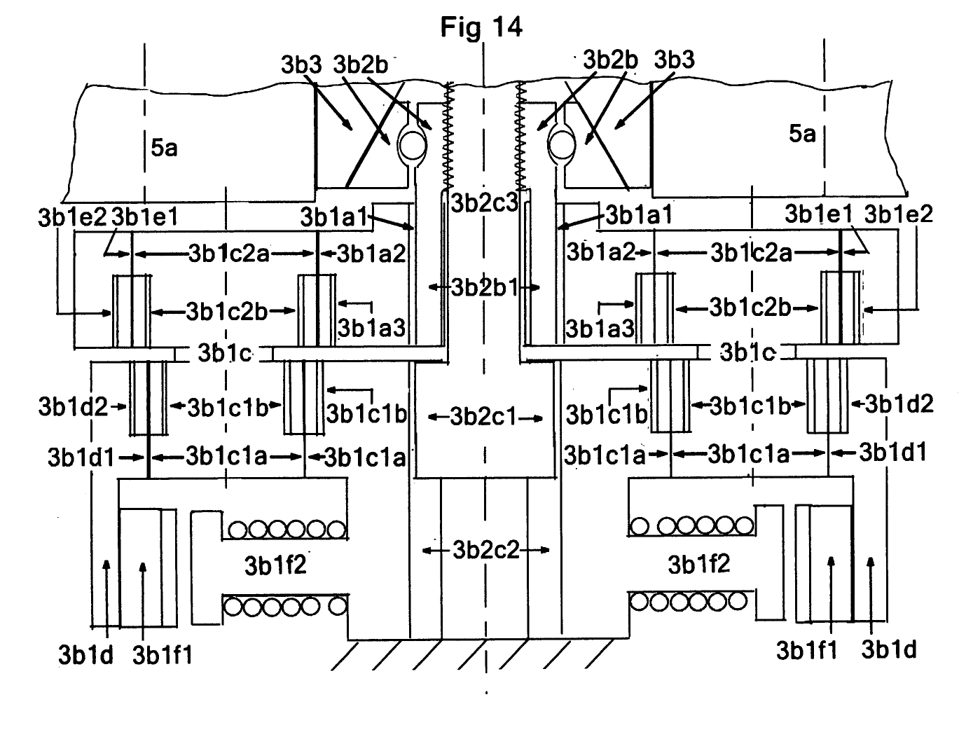

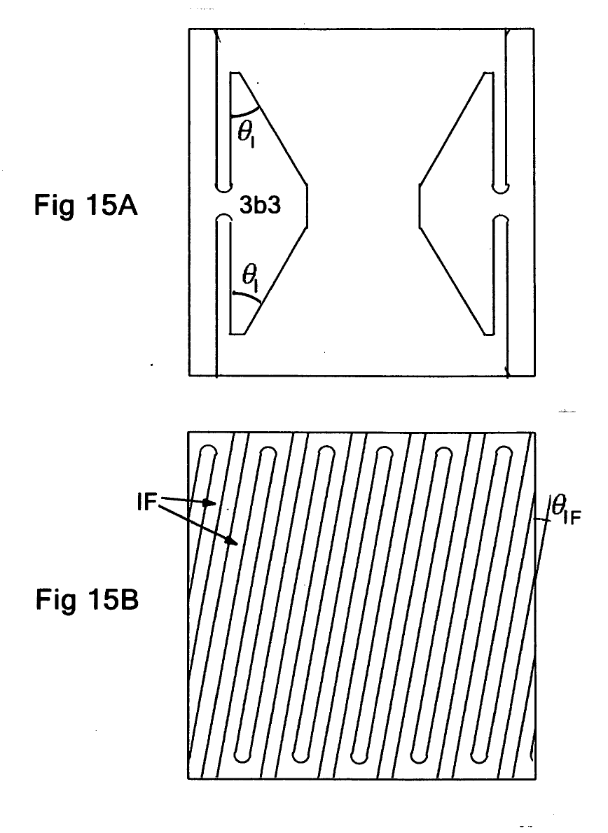

f. We will now discuss the shifting function (FIGS. 13, 14, 15A and 15). The shifting function operates according to FIG. 13 where a shifter drive gear-bearing (labeled 3b1a) is rotated by a power source. This rotation acts on a structure (labeled 3b2b1) splined to 3b1a and rotates 3b2b1 with 3b1a at the same angular velocity and about a common center of rotation. Structure 3b2b1 is attached to a threaded nut (labeled 3b2b). This nut is threaded on a screw (labeled 3c2c3). Screw 3c2c3 is splined to a fixed ground through a spline structure 3b2c1 on the screw acting on a corresponding spline structure 3b2c2 in the fixed ground and is threaded to a second nut (labeled 3b2a). The second nut (3b2a) is hard attached to screw 3c2c3 (say with a Loctite type adhesive) so when screw 3c2c3 moves along the axis of screw rotation, nut 3b2a moves with it. At the same time nut 3b2b moves along the length of the screw as per normal screw and nut threading practice, The nuts (3b2a and 3b2b) are split with roller, recirculating bearings separating the threaded portions of each of the nuts from the external portions which are in contact with radial expansion/contraction interface structure (labeled 3b3). These roller, recirculating bearings are designed to withstand both radial and axial forces so the screw can slide up and down the axis of screw rotation and nut 3b2b can move up and down the axis of the screw unaffected by the rotation of 3b3. When 3b1a is rotated in one direction, screw 3c2c3 slides down, nut 3b2b moves up and nut 3b2a moves down with the screw, resulting in nuts 3b2a and 3b2b moving towards each other. When 3b1a is rotated in the opposite direction, screw 3c2c3 slides up, nut 3b2b moves down and nut 3b2a moves up with the screw resulting in nuts 3b2a and 3b2b moving away from each other. Because of the angled interfaces between the external rings of nuts 3b2a and 3b2b and 3b3, when the nuts move towards each other, 3b3 expands radially and when the nuts move away from each other, 3b3 contracts radially. The arrangement shown in FIG. 13 allows 3b1a, 3b3 and ground stage planets 5b to be fixed along the axis of screw rotation while 3b3 expands and contracts and planets 5b move radially in and out. Structure 3b3 is also free to rotate about the center of screw rotation, while the other shift activities are happening. An embedded electric motor according to FIG. 14 can be used to power the shift system. It operates like the embedded electric motors described in FIGS. 11 and 12. It uses two-stage recirculating gear-bearing planets to rotate 3b1a with mechanical advantage and to hold 3b1a in position against back-drive with power off. The explanation for FIG. 14 will be omitted because it is essentially the same as that for each of the moveable ground rings described for FIGS. 11 and 12. Under these conditions, FIG. 14 is self-explanatory. FIGS. 15A and 15B illustrate the Radial Expansion/Contraction Interface Structure (labeled 3b3). This structure is radially expanded when the 3b2a and 3b2b nuts move towards each other, forcing the 3b3 external flexures to bend and is radially contracted by spring return when 3b2a and 3b2b move away from each other. In FIG. 15A we see the tapered structure with a taper angle of θ₁ that interfaces with threaded nuts (3b2A and 3b2B). This taper angle is sufficiently large that adequate expansion and contraction of 3b3 is achieved within the constraints of limited available linear travel of screw 3c2c3. The internal structure of 3b3 is separated from the external expanding flexures (labeled IF) except for a small section in the center of the external expanding flexures where they remain connected. In this way the external flexures expand and contract in a balanced manner and these flexures perform as though their bending properties are constant along their entire length excepting the portion where they are attached to the tapered internal structure (where insignificant bending occurs). The external expanding flexures have a thickness (labeled IF) and are at an angle (labeled θ_{w}). This angle is kept small so that the tapered internal structure does not buckle from the force of the nuts (3b2A and 3b2b), but must be large enough so that a minimum of two contacts are made with the tips of the planet 5b teeth at all times. In this way, structure 3b3 acts like an expanding roller that rolls in contact with the 5b planet tooth addendum contact. Thus, the angular velocity of 3b3 is set by the orbit and rotation angular velocity of the 5b planets. The recirculating rolling bearings separating the inner and outer nuts of 3b2a and 3b2b accommodate this requirement.

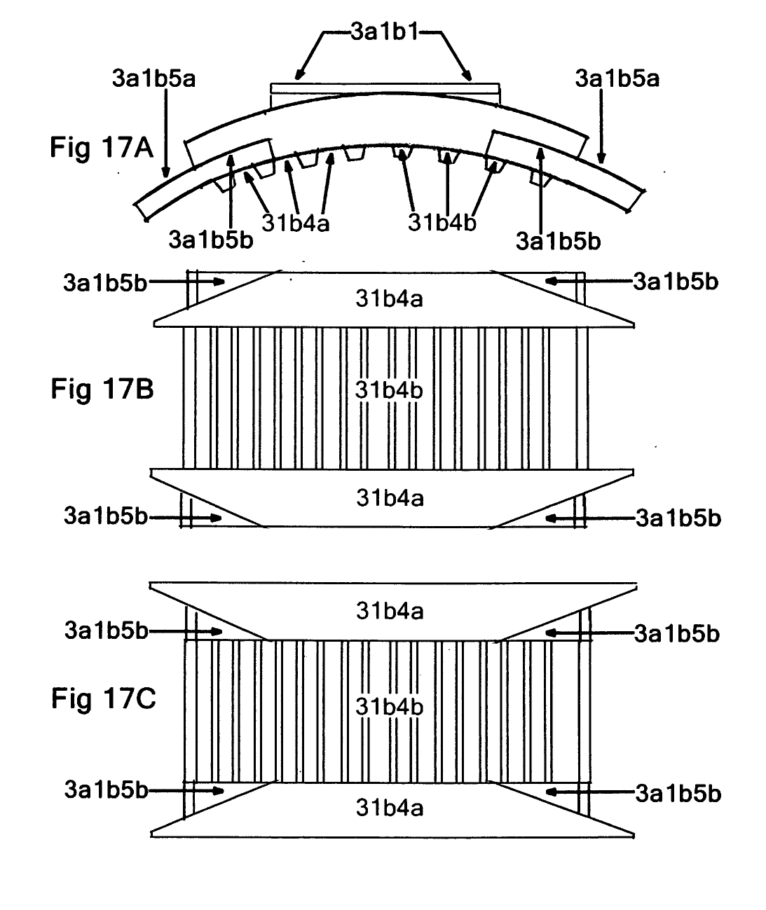

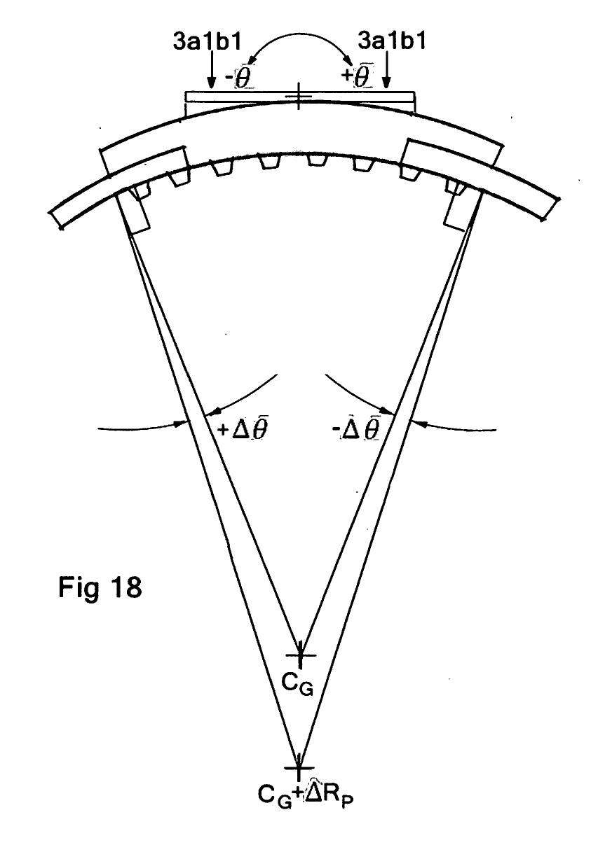

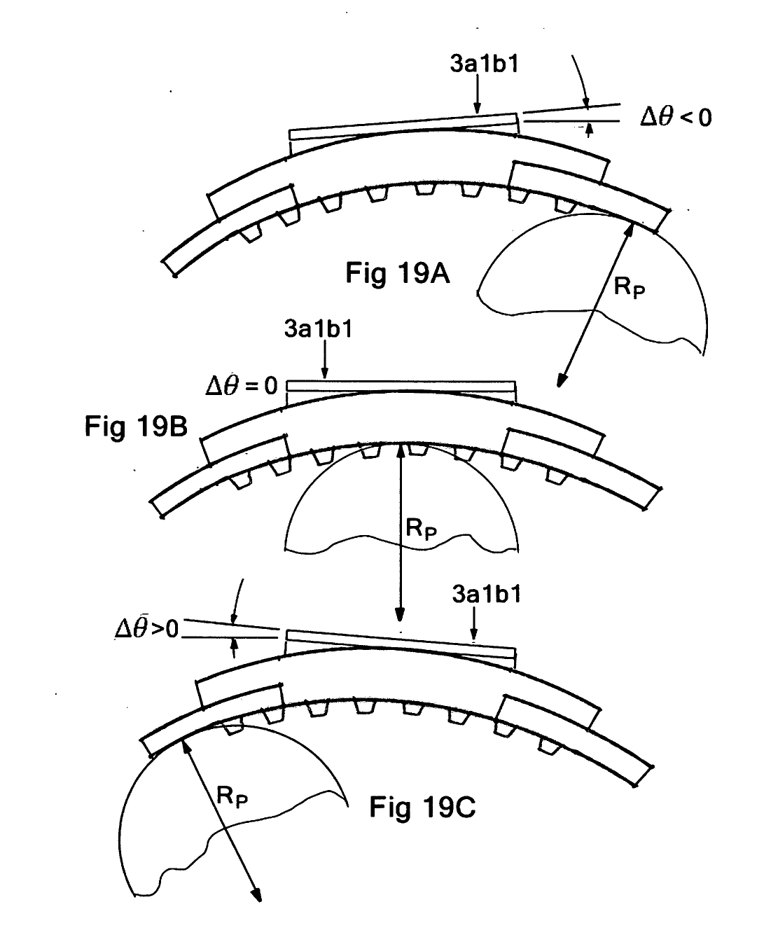

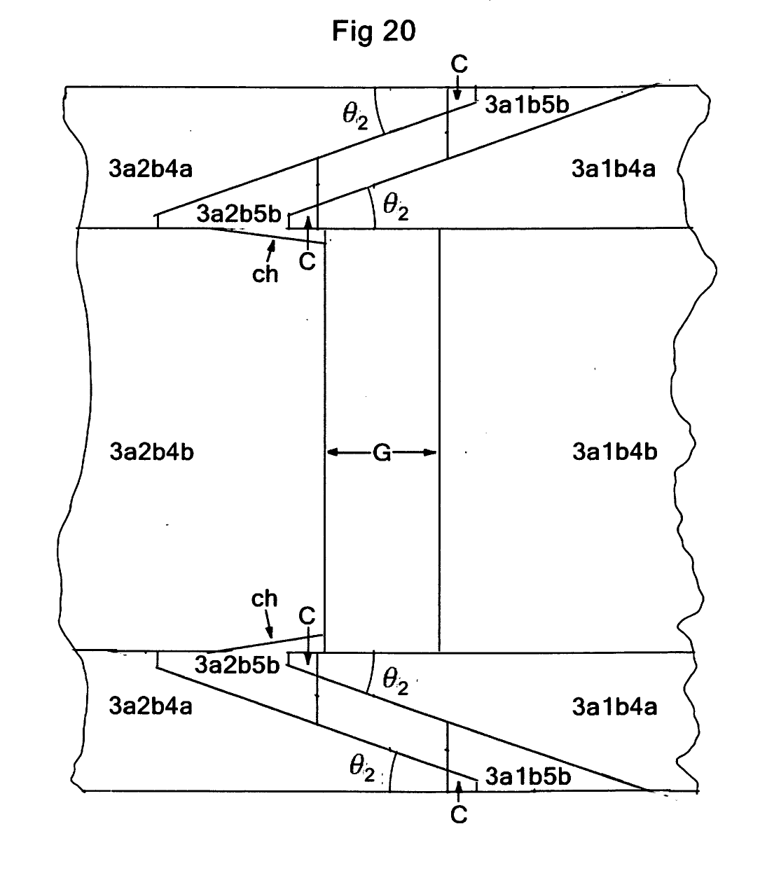

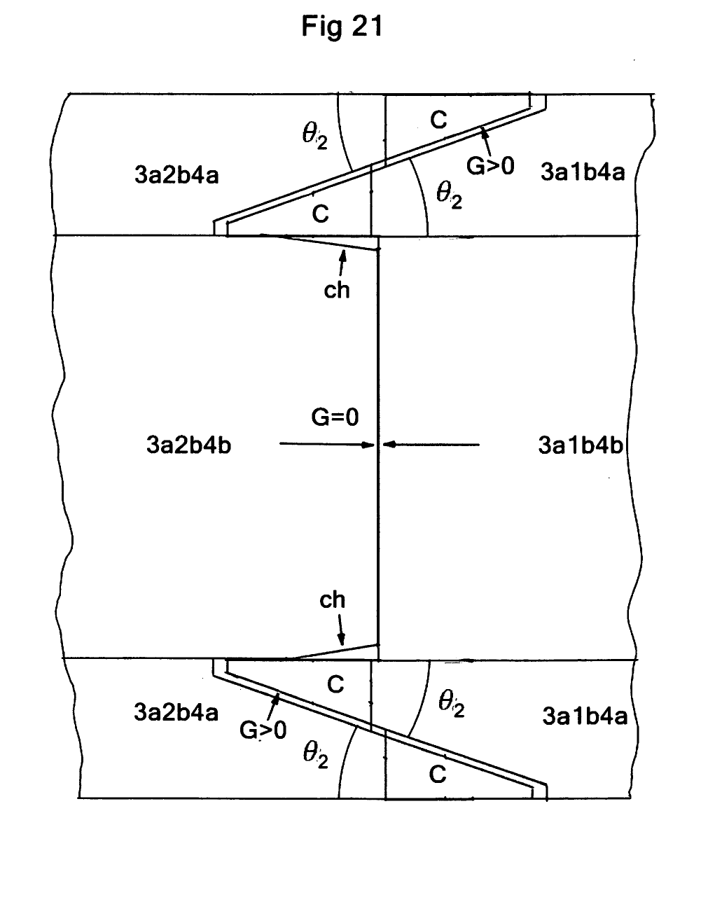

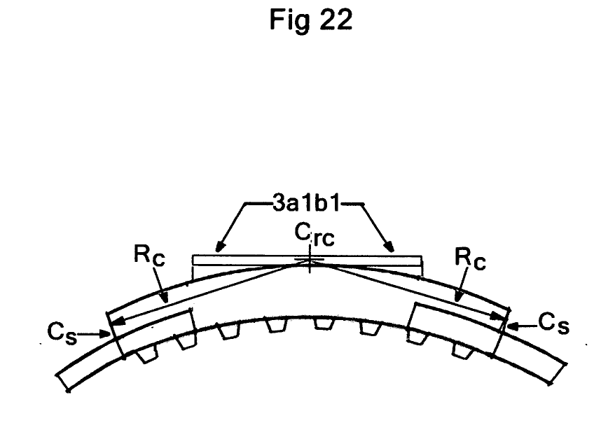

g. We will now discuss how the ground ring segments (3a1 and 3a2) respond under contact with planet ground stages (5b). We will examine the curvature correction needed by each ground section when shifted from minimum ground ring diameter, where no curvature correction is required. We will examine how a ground section turns to accommodate a ground stage planet rolling from one end of the section to the other and how this performs the curvature correction function. We will examine how a ground stage planet moves, smoothly, from contact with one ground stage to contact with another. We will examine how the eight ground sections maintain their relative positions when only four are supported by ground stage planets. We will discuss how the ground stages maintain proper alignment when one set of ground ring segments is moved into contact with the stationary set. We begin by revisiting FIG. 16 to see how the ground stage gear-bearings (5b) are configured. We then examine the configurations of a ground ring segment gear-bearing tooth & bearing race structure the ground stage planets will make contact with (FIGS. 17A, 17B and 17C). FIG. 17A shows a top view of the ground ring segment gear-bearing tooth & bearing race structure, FIG. 17B shows a face view of a type 1 ground ring segment and FIG. 17C shows a face view of a type 2 ground ring segment. For the moment we will focus on how the roller bearing races (3a1b4a) and the gear teeth (3a1b4b) are positioned to interface with the ground stage gear-bearings (5b). We note that having roller contacts above and below the gear teeth locates the gear mesh across the face width of the teeth. We also see how the roller bearing races are positioned along the pitch diameter of the gear teeth to provide smooth efficient gear and roll action between the ground stage planets and the ground ring segments. In FIG. 18 we see how curvature error occurs during radial displacement the ground ring segments (3a1 and 3a2) and how this can be corrected by pivoting the ground ring segments as a ground stage planet moves across it. When the ground ring segment is centered at C_{G}, all straight lines between C_{G} and the roller bearing races (3a1b4a) terminate on these races at a 90 deg angle. When the ground stage planet is shifted by ΔR_{P}, we have a new center for the ground ring, C_{G} ΔR_{P} where the radial lines to the roller bearing races do not all terminate at 90 deg except at the center of the ground ring segment and where the curvature error (+/−Δ) is greatest at the end points of the segment as shown in FIG. 18. When a ground stage planet rolls through a displaced ground ring segments the ground stage planet gear-bearing forces the ground ring segment gear-bearing to contact it at a 90 deg. Angle. The ground ring segment complies by pivoting ((+/−09) and curvature errors are corrected. The twist flexure springs (labeled 3a1b1) in FIGS. 18, 6, and 5, provide the compliant torsion spring force needed to hold the ground ring segment against the ground stage planet at the corrected angle while the ground stage planet is moving across the ground ring segment. FIGS. 19A, 19B and 19C illustrate this error correction in practice. FIG. 19A shows the twist flexure 3a1b1 bending −Δθ deg to comply with the ground stage gear-bearing planet requirement that contact be 90 deg. to the radius line from the CVT center when the planet is on the right side of a ground ring segment. FIG. 19B shows Δθ=0 deg. when the planet is in the center of a ground ring segment and FIG. 19C shows twist flexure 3a1b1 bending +Δθdeg. when the planet is on the left side of a ground ring segment. In this way, ground ring segment turning provides error correction and is functionally equivalent to the ring segment being bent to take out the error. There are two twist flexures as shown in FIG. 6 and these flexures are energy efficient and reliable at the small bending angles required and with their thin, tall and wide shape, they can bend easily and still withstand the large reaction torque, directed along the flexure width. The flexure thickness is sufficient to withstand the secondary forces pushing the meshing gears apart. We can now address the problem of how to radially position the four ground ring sections (3a1 or 3a2 as the case may be) that are not being contacted by the ground stage planets (5b). We begin with the maximum shift case (FIG. 20) where the gap (labeled G) between adjacent ground ring sections is largest. We note a type 1 ground ring segment (labeled 3a1b4b) and a type 2 ground ring segment (labeled 3a2b4b) are adjacent to each other across gap G so angled roller race interfaces (θ₂) can be used so when a gear-bearing roller moves from one ground ring segment to another, its rollers always remain in contact with one or both of the ground ring segments and it will avoid vibration, wear and noise caused by encountering small gaps at high rotation and orbiting speeds. FIG. 20 shows four areas (labeled C) where the ground ring segments remain in contact so one set of ground ring segments always prevents the other set of ground ring segments, unsupported by a planet gear-bearing, from moving radially inward past the supported set of ground ring segments. To clarify this we return to FIGS. 17A, 17B and 17C. In FIG. 17A we see that roller bearing race portions of the ground ring segments that are angled (θ₂) each have inner and outer surfaces that are important in aligning adjacent ground ring segments. At the largest gap, the outer surfaces of the angled portions of the roller bearing races (labeled 3a1b5a) align with the inner surfaces of the web portions (labeled 3a1b5b) such that these surfaces are concentric with the roller bearing races of the ground ring segments and congruent with each other. Thus, when the ground ring segments are spread apart the C contact areas maintain radial position for the unsupported ground ring segments in a general sense and when the unsupported ground ring segments are rotated to close the gap to zero, the alignment becomes more precise, as per FIG. 21. The combined actions of the congruent mating surfaces, the directional compliance of the moving ground ring segment twist flexure (3a1b1) and the ground stage planet determined position of the stationary ground ring segment provide precision alignment by compliance. This precision alignment is sufficient that as a ground stage planet (5b) moves from one ground ring segment to another there is very little vibration, noise and wear and the alignment precision improves yet again as the ground stage planet rollers move onto the roller bearing races of the newly supported ground ring segments. For some period, all ground ring segments are supported by the ground stage planets. A transition between ground ring segments is complete when the rollers of the ground stage planets clear the angled portions of the old ground ring segment and the old ground ring segment is now free to rotate to become the new ground ring segment. It is safe to move earlier, once the planet gear mesh has transferred to the new ground ring section, but there will be some rubbing between the planet rollers and the moving ground ring segment roller bearing races. In FIG. 21 we see contact occurs between ground ring segments along their geared sections We note that for the type 2 ground ring segments, there are chamfered sections (labeled ch) so the roller bearing races of type 1 ground segments do not jam against the geared sections of type 2 ground ring segments to disturb the alignment precision. We also note that there is slight clearance between the angled portions of the roller bearing races of the mating ground ring sections to eliminate interference to precise alignment between the gears from one ground ring section to another. Also, we note the web (3a1b5b) edges are moved back slightly from the geared sections of both type 1 and type 2 ground ring segments to prevent contact between geared sections and web edges to reduce precision contact between gear sections. FIG. 22 illustrates detail on the gear section to gear section alignment. We see the gear section contact surfaces (labeled C_{S}) are cylindrically shaped with a center (C_{rc}) at the center of the twist flexure (3a1b1), with radius R_{C}. Thus, for small angles of flexure twist. The gear section to gear section contacts are rolling together at equal speeds with minimum rubbing. This promotes precise and efficient alignment is the direction of ground ring segment twist.

### 3. The Two-Stage Variable Displacement Planets

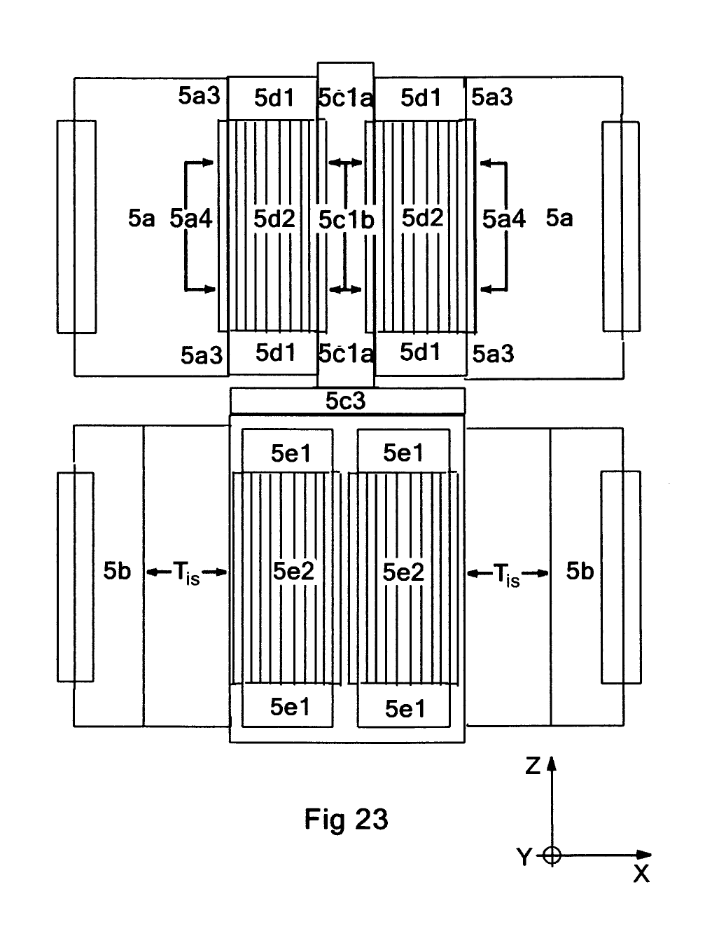

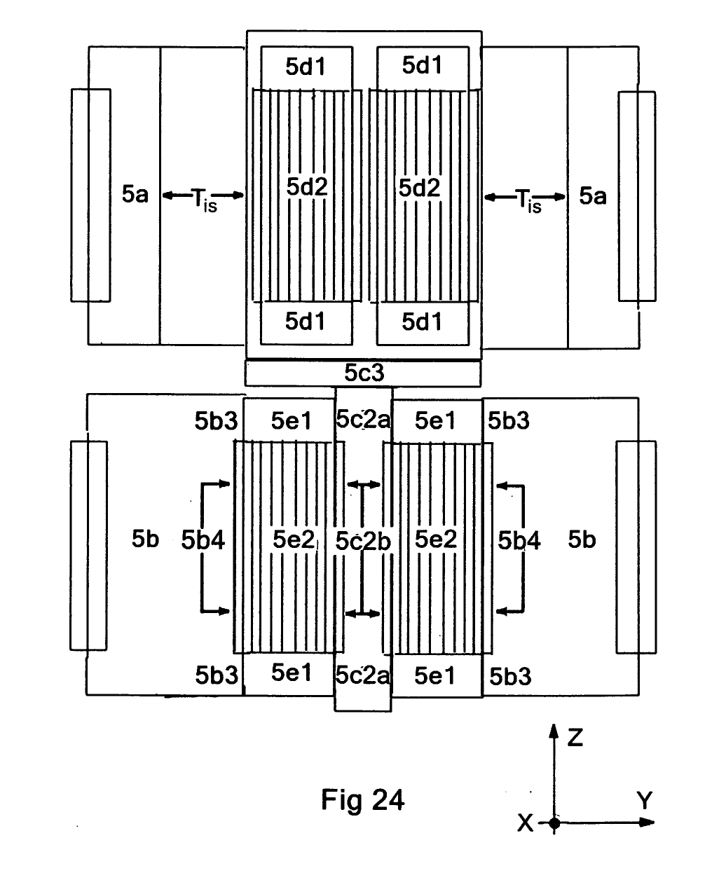

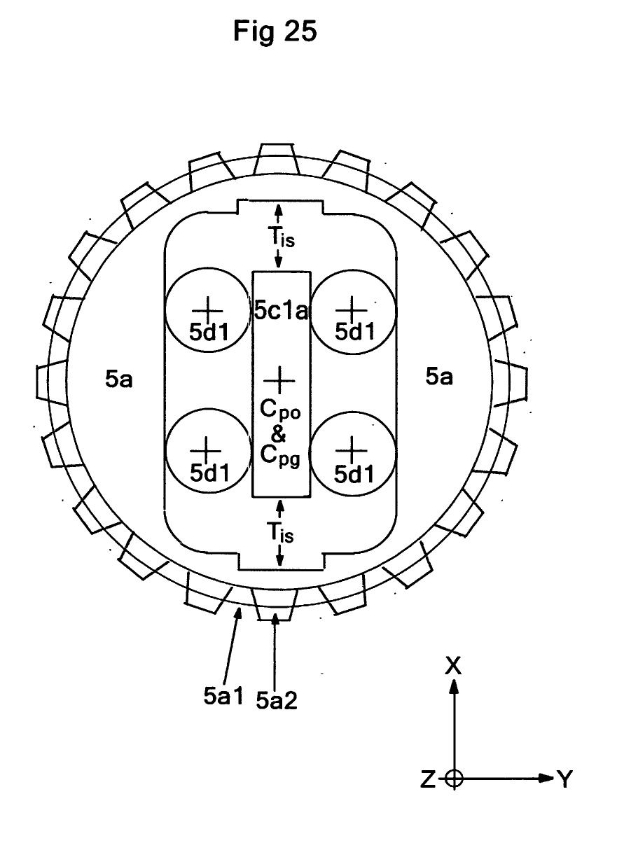

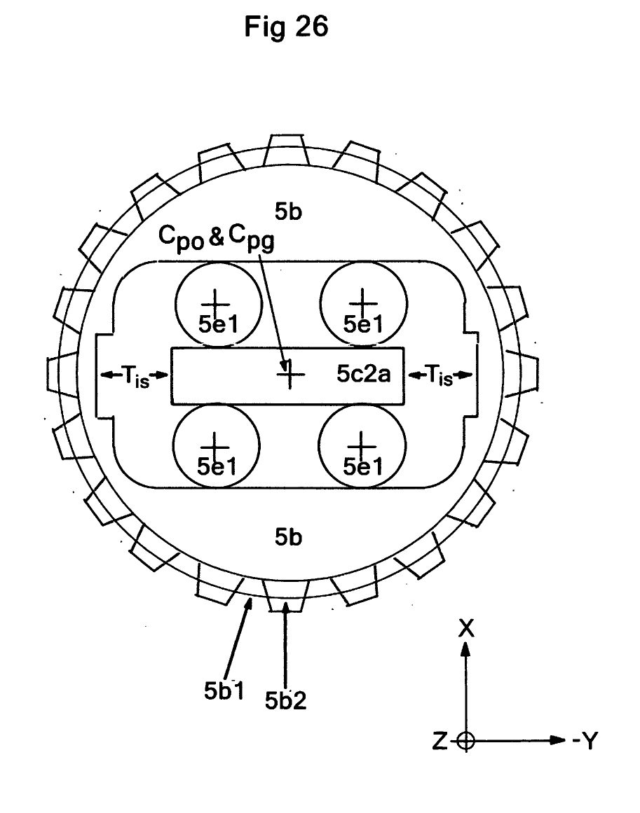

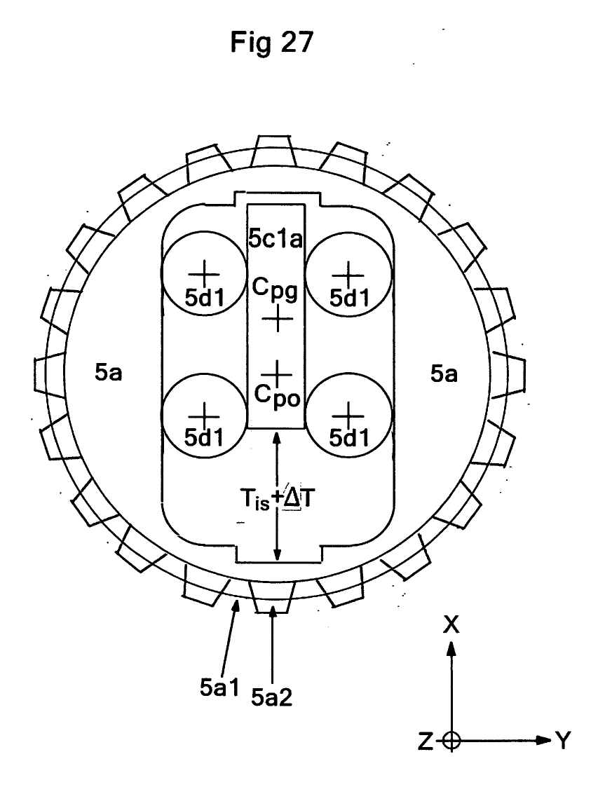

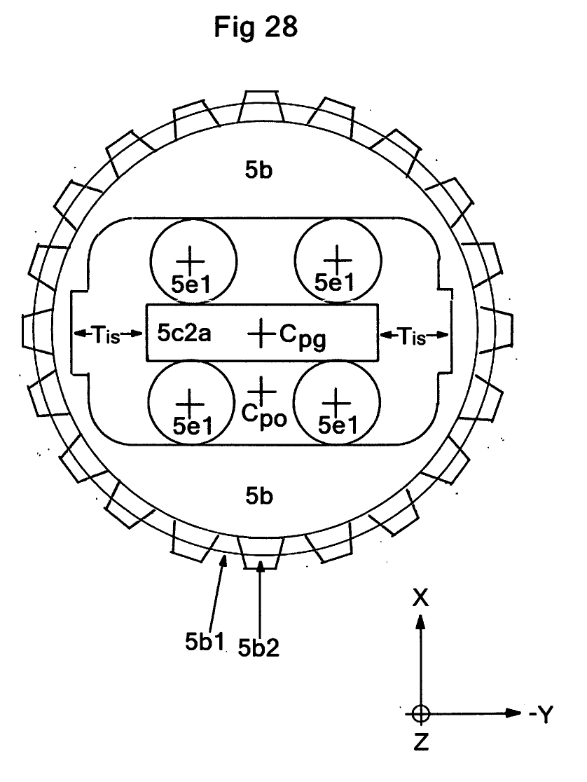

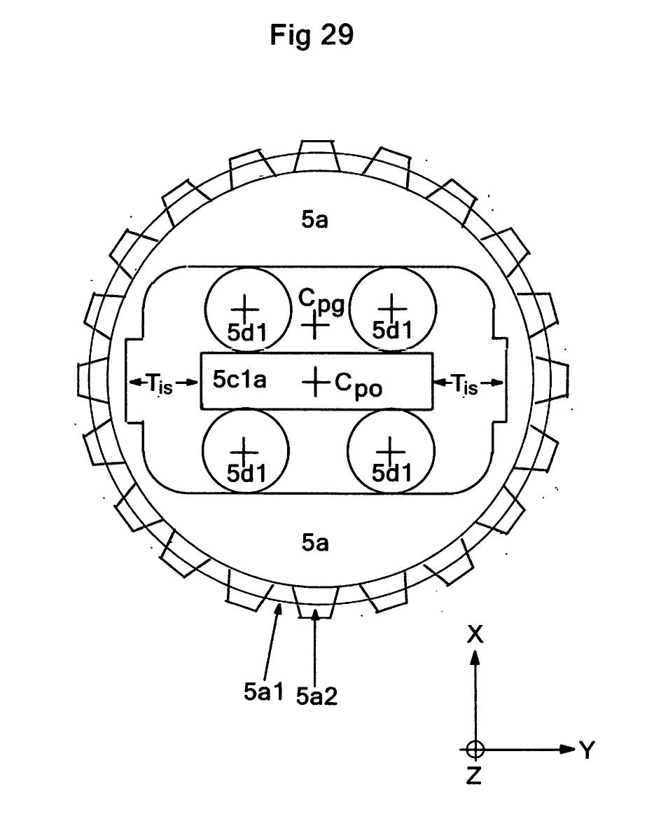

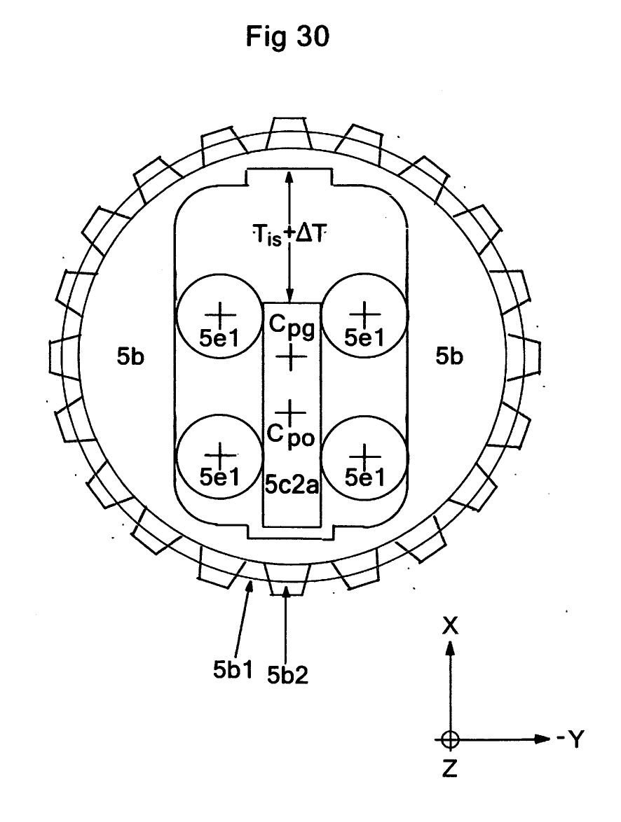

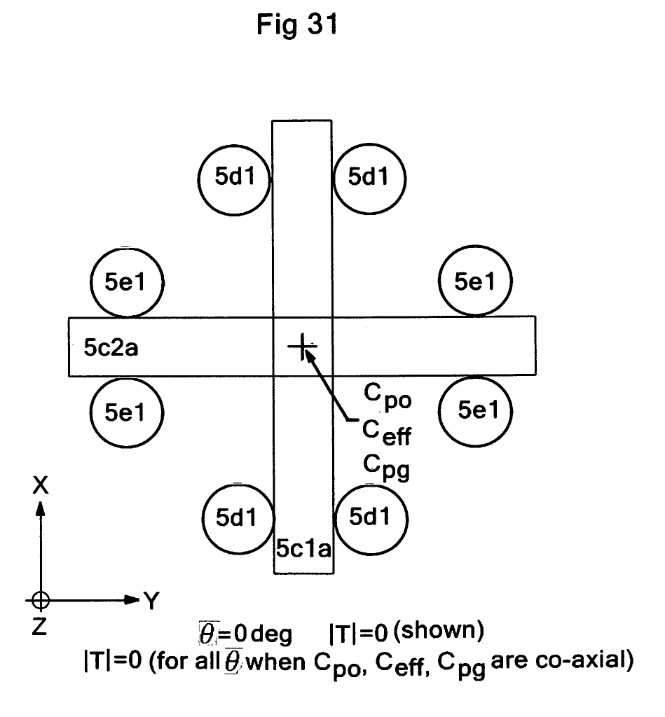

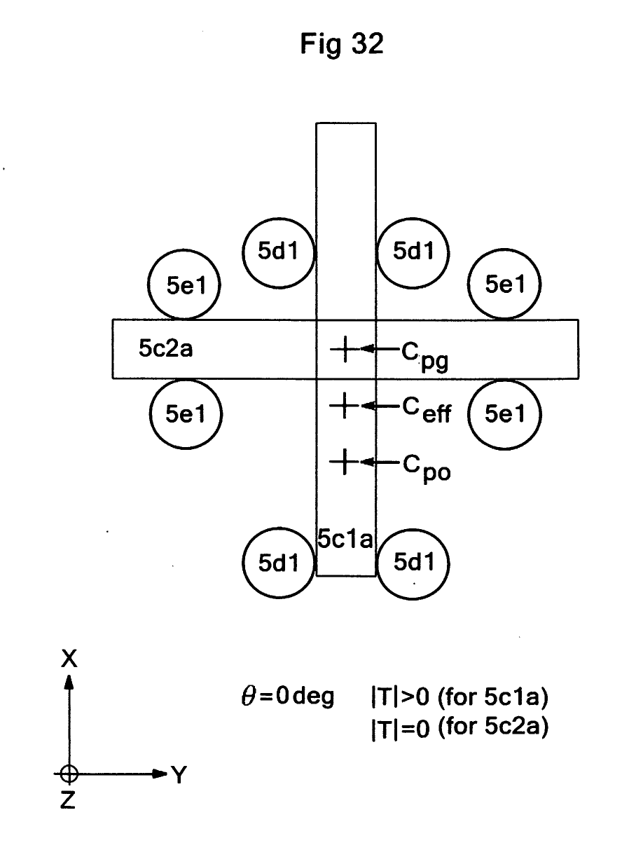

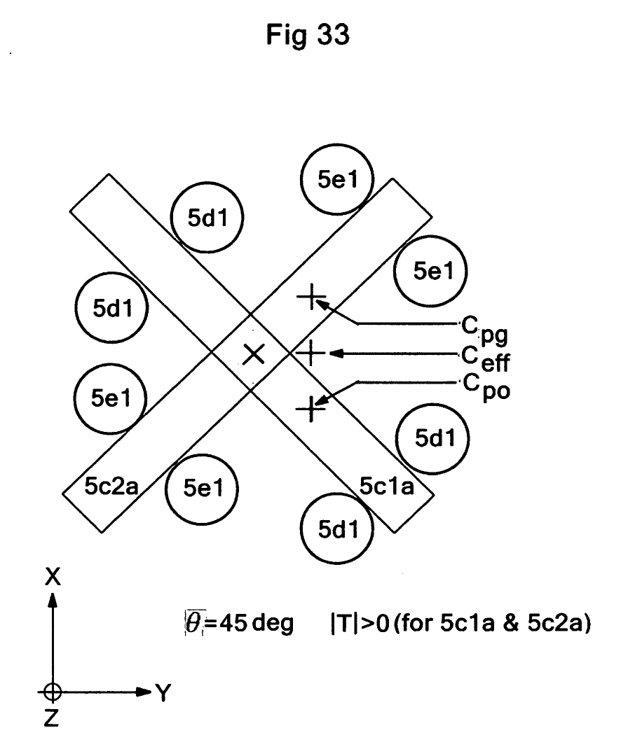

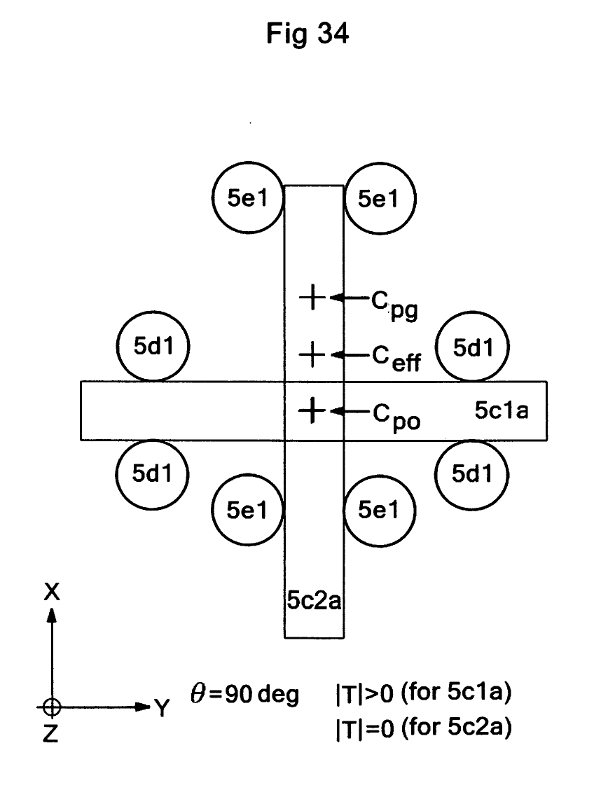

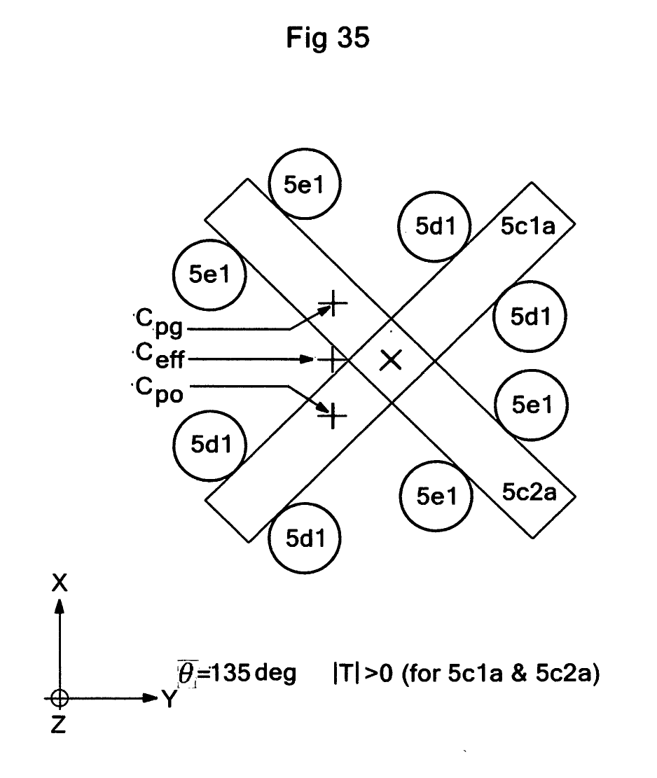

We will now discuss how the input/output and ground stage planets are combined to form two-stage variable displacement planets and how the ground stage of each displaces with respect to its input/output stage.
a. We first explain the construction of a two-stage variable displacement planet in FIGS. 23 and 24. These Figs. show two-stage variable displacement planets in their simplest configuration so as to introduce the concept without too many confusing complications. FIG. 23 shows one cross-section view of the inner/outer stage planet (labeled 5a), the ground stage planet (labeled 5b), the planet interface shaft (5c), the gear-bearing rollers (5d) that couple the planet interface shaft to the input/output stage planet and the gear-bearing rollers (5e) that couple the planet interface shaft to the ground stage planet. The gear-bearing rollers (5d) are constructed with a gear (5d2) in the center and a roller (5d1) on each of its ends and the gear-bearing rollers (5e) are constructed with a gear (5e2) in the center and a roller (5e1) on each of its ends. Gear-bearing rollers (5d and 5e) are typically identical, but are labeled separately so we can follow their individual movements with maximum clarity. The sections of the input/output stage planets that mate with gear-bearing rollers (5d), have geared sections (labeled 5a4) and roller bearing race sections (labeled 5a3). The sections of the ground stage planets that mate with gear-bearing rollers (5e) have geared sections (labeled 5b4) and roller bearing race sections (5b3). The planet interface shaft (5c) has a rectangular section (5c1) that interfaces with gear-bearing rollers (5d) and an input/output planet (5a), a rectangular section (5c2) that interfaces with gear-bearing rollers (5e) and a ground stage planet (5b) and a cylindrical section (5c2) that joins rectangular sections (5c1) and (5c2). The cylindrical section (5c3) has a diameter equal to the width of the rectangular sections (5c1) and (5c2) and has minimal height. Its purpose is to add area between the rectangular sections against shear and bending between the rectangular sections under loads. The rectangular section (5c1) has a geared section (5c1b) and roller bearing race sections (5c1a) and rectangular section (5c2) has a geared section (5c2b) and roller bearing sections (5c1b). FIG. 24 shows a side section view of the two-stage variable displacement planet of FIG. 23, but rotated 90 deg. The gear-bearing rollers as shown in FIGS. 23 and 24 provide reliable location during two-stage shift planet because they are geared and cannot wander. Also their roller contacts top and bottom provide excellent resistance to tilt about one coordinate axis and their gear teeth provide excellent resistance to tilt about a second axis orthogonal to the first axis. This leaves the third axis of travel in which they are free to travel with low friction rolling, even under load. In FIG. 25, we look at the input/output stage from a top down view. For clarity we omit the geared elements and focus on the roller elements (5d1). Also, we spread the rollers apart. We note that the center of rotation (Cₚₒ) for planet stage (5a) is directly above the center of rotation (C_{pg}) for planet stage (5b) and there is room for (5c1a) to move (Tᵢₛ) in the +/−X direction. In FIG. 26 we look at the ground planet stage from the bottom up view, again using spread rollers (5e1) for clarity. We note, again, planet stage (5b) is directly above planet stage (5a) and there is room for (5c2a) to move (T_{SS}) in the +/−Y direction.
b. We will now discuss two-stage shift planet operations. We can see that, in the no shift situation, planet stages (5a) and (5b) will rotate together and that (Cₚₒ) and (C_{pg}) will remain co-axial for any and all angles of rotation. In FIG. 27, we revisit the top down view of FIG. 25, with the rotation angle set at 0 deg, and shift ground stage planet (5b) in the +X direction a ΔT distance. This forces planet interface shaft (5c) to move ΔT in the +X direction as well. When (5c) moves ΔT in the +X direction, rollers (d1) move 0.5 ΔT (half as far) in the +X direction and we have the arrangement shown in FIG. 27. From a bottom up view point, we now have the arrangement shown in FIG. 28. In the FIG. 28 view, the rollers (5e1) have been displaced (ΔT) in the +X direction, but have not moved with respect the planet interface shaft (5c). Comparing FIGS. 27 and 28, we see the planet stage (5b) center of rotation (C_{pg}) has been displaced (ΔT) in the +X direction, while planet stage (5c) center of rotation (Cₚₒ) remains at X=0. The planet interface shaft has moved with the planet ground stage (5b). The rollers (5d1) have rolled down the planet interface output stage shaft (5c1) the distance (0.5 ΔT). The rollers (5e1) have not rolled along the planet interface ground stage shaft (5c2). We, now, rotate the two stage planets, described in FIGS. 27 and 28, 90 deg. and examine them again. In the new top down view of (5a) as per FIG. 29, we see (5c1) has moved back to +X=0 and rollers (d1) have rolled back up (5c1) a distance of (0.5ΔT) and the situation has returned to equal gaps of (Tᵢₛ) on both sides of (5c1) with (ΔT=0). In the new bottom up view of (5b) as per FIG. 30, we see, (5c2) has moved back to +X=0 and rollers (5e1) have rolled up (5c2) a distance of (0.5 ΔT). Thus a gap (T+ΔT) has opened between the shaft (5c2) and planet stage (5b). Comparing FIGS. 27, 28, 29, 30 we see, with a ground stage planet displacement of (ΔT), The planet interface shaft (5c) moves between X=0 and X=+(ΔT) and the (5d) and (5e) gear-bearing rollers move between X=0 and X=+(0.5ΔT). The gear-bearing rollers always remain in contact with the shaft (5c) and are always able to transmit torque from the ground stage to the input/output stage and vice versa. We can also see limits (ΔT) to the amount we can shift. Our information to this point suggests the interface shaft system with internal gear-bearing rollers will support shifting and transferring large amounts of torque between ground and input/output stages will work, but we need to examine what happens to two-stage shift planet for rotation angles between 0 and 360 deg. and include angles such as 45 deg., 135 deg., 225 deg. and 315 deg. to further our understanding and confidence.
c. We will now revisit the discussion of h, immediately above, and include angles between 0, 90, 180 and 270 deg. in 45 deg. increments to fill in our understanding of two-stage variable displacement planet behavior. We are particularly interested in the location and movement of the planet interface shaft portions (5c1a) and (5c2a) and of the gear-bearings operating on these portions. To better visualize this, we simplify the drawings and spread the gear-bearing rollers so we can visualize what happens from a top down view without the upper gear-bearing rollers interfering with our view of the lower gear-bearing rollers. We start with FIG. 31, where θ=0° and ΔX=0. This helps us acclimate to the new spread gear-bearing roller format under the simplest conditions. In FIG. 32, we introduce an offset of +ΔX (or T) while leaving θ=0°. This is the equivalent of shifting the planet ground stage an amount of +ΔX (or T) and results in three centers of rotation, C_{pg} for the planet ground stage, Cₚₒ for the planet input/output stage and C_{eff} for the planet interface shaft (5c), also the intersection between the centerlines of (5c1a) and (5c2a). In FIG. 33, we see what happens when the two-stage shift planet is rotated 45 deg. counterclockwise from FIG. 32 conditions. (We are calling counterclockwise angles as positive.) We note that the (5c1a), (5c2a) shaft has rotated 45 deg. and the intersection of the (5c1a), (5c2a) shaft is at 0.5 ΔX and −0.5 ΔY. Rollers 5d1 have moved up shaft (5c1a) a distance 0.25 ΔX (or 0.25 T) and rollers 5e1 have moved down shaft (5c2a) a distance 0.25 ΔX (or 0.25 T) from FIG. 32 conditions. (We deduce the movement of these rollers using superposition. The rollers do not move with respect to their shaft during rotation, but they do move during translation. The amount they move is half the amount of the translation. Spacing between rollers on a shaft is constant.). In FIG. 34, we see what happens when the (5c1a), (5c2a) shaft rotates 90 deg. counterclockwise from FIG. 32 conditions. We see shaft (5c2a) is now centered at Cₚₒ aligned with the X axis and shaft (5c1a) is now centered at Cₚₒ aligned with the Y axis. The 5e1 rollers have moved up shaft (5c2a) a maximum amount and the 5d1 rollers are centered on shaft (5c1a). In FIG. 35, we see what happens when the (5c1a), (5c2a) shaft rotates counterclockwise 135 deg. from FIG. 32 conditions. The rotated (5c1a), (5c2a) shaft is now centered at 0.5 ΔX and +0.5 ΔY. Rollers 5d1 have moved down shaft (5c1a) a distance 0.25 ΔX (or 0.25 T) and rollers 5e1 have moved up shaft (5c2a) a distance 0.25 ΔX (or 0.25 T) from FIG. 34 conditions. With the behavior pattern established we can deduce behavior for rotation angles, 180 deg., 225 deg., 270 deg., 315 deg. etc. At 180 deg. we will be back to the arrangement shown in FIG. 32 except for one interesting difference. In FIG. 32 we tagged one end of shaft (5c1a) with the shaft label and we tagged one end of shaft (5c2a) with the shaft label. At 180 deg. rotation counterclockwise from FIG. 32 conditions, the positions of these tags will be reversed. Also the rollers will be reversed. None of this has any practical bearing on performance, but is an interesting curiosity. It actually takes two full rotations of the two-stage shift planet for the planet interface shaft system to complete one full cycle and the shaft gear-bearing rollers will complete two oscillations up and down each of their respective shafts during this period.

### 4. The Speeder

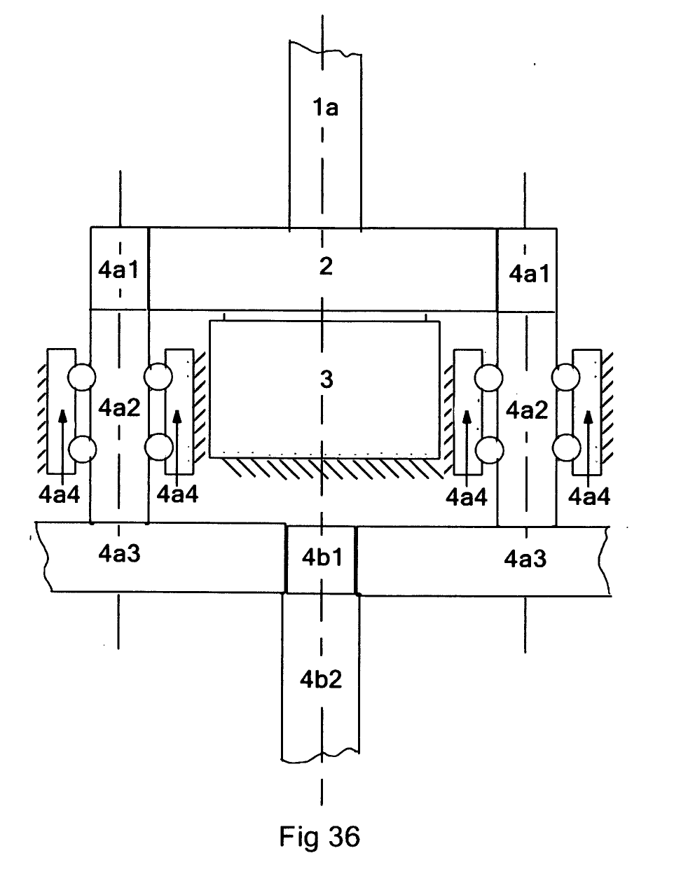

We will now discuss the speeder (FIG. 36) that is required to transfer the low angular velocity, high shift range SGGT output to a higher angular velocity output, with high shift range, useful in certain applications such as automobiles.
a. The speeder provides a fixed speed multiplier across all angular velocities. As per FIG. 36, input power is supplied to the SGGT system by a rotating input geared shaft (labeled 1a). The input power is shifted in angular velocity by the SGGT system comprising (1a), input/output stage (labeled 2 in FIG. 36) and ground stage (labeled 3 in FIG. 36) and this shifted angular velocity is exported to the speeder through two speeder input idler gears (labeled 4b1) positioned diametrically opposite with respect to the input/output stage. Input idler gears (4b1) are co-axially fixed to output idler gears (4b2) and the resulting two-stage idler gears are each fixed to ground by means of a shaft (labeled 4b3) and recirculating rolling bearings (ball bearings in the FIG. 36 example). The idler gears (4b2) each inputs mechanical power to the first gear (labeled 4c1) of a transfer shalt (labeled 4c3) and each transfer shaft, in turn, transfers mechanical power from the input/output stage to some location beyond the SGGT ground stage where the transferred mechanical power is exported from a second gear for each transfer shaft (4c2) to a first output idler gear (labeled 4d1). Each transfer shaft is supported and located with respect to ground by a recirculating rolling friction bearing system (labeled 4c4). The mechanical power imported by each output idler gear (4d1) is transferred to a co-axial second output idler gear (4d2) and exported to the speeder output geared shaft (labeled 4e). Each two-stage output idler gear is fixed to ground by a recirculating rolling friction bearing system (labeled 4d3). The mechanical power transferred to (4e) is the sum of the mechanical power contributions of each of the (4d2) exports. The speeder mechanical advantage is the product of the mechanical advantage of the SGGT output to idler input (4b1) times the mechanical advantage of the idler output (4b2) to the transfer shaft input (4c1) times the transfer shaft output (4c2) to the output idler input (4d1) times the output idler output (4d2) to the speeder output shaft (4e). The speed increase is one divided by the speeder mechanical advantage. The speeder mechanical advantage and speed increase factor are calculated as lossless. The system is geared and speed will be governed by relative distances traveled by each of the meshing components. There will be losses in the system and these will be reflected by a reduction in torque at the speeder output. We will estimate the output torque as the lossless torque times an efficiency factor. This efficiency factor can be estimated from empirical studies of losses typically sustained in gear tooth to gear tooth contacts under load conditions.

### 5. Governing Equations

Governing equations will be derived for selected functions in the SGGT system. The equations governing the shift range available from the ground stage will be derived. As part of this, the maximum radial displacement of each of the ground stage planets will be derived along with the movement of each of the gear-bearing rollers, therein. The equations governing the performance of the shift system, needed to support the required shift planet performance, will also be derived. With this information available, the equation for speed reduction of the SGGT system, without speeder, will be determined. Equations for determining torque capabilities of the SGGT system, without speeder, will also be derived. A method will be determined for estimating losses (mechanical efficiency) of the SGGT system, without speeder. At this point, the equations governing speeder performance, will be derived.
a. We derive speed reduction equations for the SGGT, using relative tooth speeds, assuming lossless operations.

Where:

$${ω}_{S} = Input Sun angular speed$$

$${ω}_{P} = Planet angular speed$$

$${ω}_{PO} = Planet angular speed of orbit$$

$${ω}_{RO} = Output Ring angular speed$$

$$\begin{matrix}MA = \frac{{R}_{S} {ω}_{S}}{{R}_{R} {ω}_{RO}} = \frac{motion distance in}{motion distance out} & eq ( 1 ) \\ {R}_{S} {ω}_{S} = {R}_{S} {ω}_{PO} + {R}_{P} {ω}_{P} ( matching tooth speeds at Sun ) & eq ( 2 ) \\ {R}_{R} {ω}_{RO} = {ω}_{PO} {R}_{R} - {ω}_{P} {R}_{P} ( matching tooth speeds at Ouput Ring ) & eq ( 3 ) \\ {ω}_{PO} ( {R}_{R} + Δ {R}_{R} ) - {ω}_{P} {R}_{P} = 0 ( matching tooth speeds at Ground Ring ) & eq ( 4 ) \\ {ω}_{PO} = {ω}_{P} \frac{{R}_{P}}{{R}_{R} + Δ {R}_{R}} ( rearranging eq ( 4 ) & eq ( 5 ) \\ {R}_{S} {ω}_{S} = {R}_{S} {ω}_{P} \frac{{R}_{P}}{{R}_{R} + Δ {R}_{R}} + {R}_{P} {ω}_{P} ( substituting eq ( 5 ) into eq ( 2 ) ) & eq ( 6 ) \\ {R}_{S} {ω}_{S} = {ω}_{P} {R}_{P} ( \frac{{R}_{S}}{{R}_{R} + Δ {R}_{R}} + 1 ) ( rearranging eq ( 6 ) & eq ( 7 ) \\ {R}_{R} {ω}_{RO} = {ω}_{P} \frac{{R}_{P}}{{R}_{R} + Δ {R}_{R}} {R}_{R} - {ω}_{P} {R}_{P} ( substituting eq ( 5 ) into eq ( 3 ) \\ So \text{:} & eq ( 8 ) \\ {R}_{R} {ω}_{RO} = {ω}_{P} {R}_{P} ( \frac{{R}_{R}}{{R}_{R} + Δ {R}_{R}} - 1 ) ( rearranging eq ( 8 ) & eq ( 9 ) \\ MA = \frac{( \frac{{R}_{S}}{{R}_{R} + Δ {R}_{R}} + 1 )}{( \frac{{R}_{R}}{{R}_{R} + Δ {R}_{R}} - 1 )} ( substituting eq ( 7 ) and eq ( 9 ) into eq ( 1 ) ) & eq ( 10 ) \\ MA = \frac{( {R}_{R} + {R}_{S} + Δ {R}_{R} )}{( {R}_{R} - {R}_{R} - Δ {R}_{R} )} = - ( \frac{{R}_{R} + {R}_{S}}{Δ {R}_{R}} + 1 ) ( rearranging eq ( 10 ) & eq ( 11 )\end{matrix}$$

We note the output direction is opposite the input direction. This is a result of using a planet ground stage that is displaced radially rather than a planet not displaced radially, but with a variable planet radius (not considered practical).

We now express MA in terms of tooth counts. We know:

$${R}_{R} = \frac{{n}_{R}}{2 π} {R}_{S} = \frac{{n}_{S}}{2 π} and Δ {R}_{R} = \frac{Δ {n}_{R}}{2 π} \qquad eq ( 12 )$$

Because all these gears share a common tooth pitch (circular pitch in eq (12)). Diametral pitch would have worked equally well. So:

$$MA = - ( \frac{{n}_{R} + {n}_{S}}{Δ {n}_{R}} + 1 ) ( substituting eq ( 12 ) euivalents into eq ( 11 ) ) \qquad eq ( 13 )$$

We now examine the displacement between planet ground stage and planet input stage required to adequately vary MA. We start with:

$$\frac{- ( {R}_{R} + {R}_{S} )}{( MA + 1 )} = Δ {R}_{R} = Δ {R}_{P} ( Disp ) ( rearranging eq ( 11 ) \qquad eq ( 14 )$$

Or alternately in tooth count form:

$$\frac{- ( {n}_{R} + {n}_{S} )}{( MA + 1 )} = Δ {n}_{R} = Δ {n}_{P} ( Disp ) ( rearranging eq ( 13 ) \qquad eq ( 15 )$$

b. We now examine the shift range capabilities of a SGGT. We try some nominal values to get a feel for shift range and its properties. We start with a planetary system with Sun and Planets 20 teeth each with a fixed output ring of 60 teeth and an adjustable ground ring of 60 teeth divided into eight (8) diametrically opposite sections. Two sets of diametrically opposite sections have seven (7) teeth in each section and two sets of diametrically opposite sections have eight (8) teeth in each section.

$$\frac{π ( {D}_{R} + Δ {D}_{R} - {D}_{R} )}{CP} = Δ {n}_{R} = \frac{πΔ {D}_{R}}{CP} = \frac{2 πΔ {R}_{P} ( Disp )}{CP} CP = \frac{π {D}_{S}}{{n}_{S}} = \frac{π {D}_{R}}{{n}_{R}} = \frac{π {D}_{P}}{{n}_{P}} \qquad eq ( 16 )$$

Maximum Allowable Blade Width=2(Rₚ−ΔRₚ(Disp)).

$${n}_{S} = 20 {n}_{R} = 60 {n}_{P} = 20 {D}_{S} = 2 in {D}_{P} = 2 in {D}_{R} = 6 in CP = \frac{π}{10} \qquad eq ( 17 )$$

TABLE 1
(PLANET SHIFT PROPERTIES)*

| | | | | Bearing | Max Blade | |
|---|---|---|---|---|---|---|
| Δn_{R} | MA | ΔR_{P}(Disp) | $\frac{{R}_{P}}{2}$ | Travel | Width | |
| 0 | ∞ | 0 in | 0.5 in | 0 in | 2.000 in | (OK) |
| 0.2 | −801 | 0.005 in | 0.5 in | 0.0025 in | 1.999 in | (OK) |
| 1 | −161 | 0.025 in | 0.5 in | 0.0125 in | 1.950 in | (OK) |
| 2 | −81 | 0.050 in | 0.5 in | 0.0250 in | 1.900 in | (OK) |
| 4 | −41 | 0.100 in | 0.5 in | 0.050 in | 1.800 in | (OK) |
| 6 | −27.6667 | 0.150 in | 0.5 in | 0.0750 in | 1.700 in | (OK) |
| 8 | −21 | 0.200 in | 0.5 in | 0.100 in | 1.600 in | (OK) |
| 10 | −17 | 0.250 in | 0.5 in | 0.125 in | 1.500 in | (OK) |
| 12 | −14.3333 | 0.300 in | 0.5 in | 0.150 in | 1.400 in | (OK) |

Values are nominal and are subject to detail adjustment in the design and development of a practical device. Values are based on a chosen set of design parameters and will change as the design parameters change.

The max blade width will support gear-bearing rollers with a diameter slightly less than maximum blade width-2 times bearing travel

For MA=−44.33333, roller diameter<1.400−0.300=1.100. From a practical standpoint, gear-bearing rollers=0.5 in diameter should suffice. A diameter of 0.625 in may also fit. The gear-bearing rollers are separated by 1 in. on a 1.400 in blade. This leaves 0.200 in on each end of the blade as overhang past gear-bearing blade contact. The blade moves a maximum of 0.300 in. and the rollers move 0.150 in in the same direction. The rollers, then, move 0.150 in w/respect to the blade, leaving 0.200−0.150=0.050 in margin. For a gear-bearing roller dia. 0.625 in, with 20 teeth, the tooth width or gap width between teeth is approximately:

$$\frac{π \cdot 0.625}{40} = 0.0490873852123 in \qquad eq ( 18 )$$

So: we have room enough for one tooth as a safety factor.

The tooth width of the ground stage planet is based on a 2 in. planet dia. with 20 teeth. The tooth width is approximately equal to the distance from the gear pitch circle to gear dedendum circle.

$$\frac{π \cdot 2}{40} = 0.15707963267895 in = tooth width of ground stage planet \qquad eq ( 19 )$$

We find the design conditions based on MA=−14.333 and a ground stage planet gear of 2 in dia. to be demanding and the benefits in achieving MA=−14.333 as opposed to MA=−21 to be unimportant. In either case a speeder will be needed.

We try conditions for MA=−21

2 in−2·0.1570796326795 in−2·0.020 in=Max Slot Width=1.645840734641 in

Max Slot Width−2·ΔRₚ(Disp)=Blade Width=1.245840734641 in eq (20)

Blade Width−2·Bearing Travel—2·Bearing Tooth Width=Bearing Center Sep 1.245840734641 in −2·0.100 in−2·0.0490873852123 in=Bearing Center Sep

Bearing Center Sep=0.9476659642164 in(OK for 0.625 in dia Bearings) eq (21)

We estimate a Blade Thickness of 0.375 in should suffice and 0.25 in can be used if required. Blade Thickness does not seem to be a critical design factor.

We have discussed the design of the blade width, the slot width, the gear-bearing rollers and the spacing between the gear-bearing rollers in terms of the ground stage planets, but these relationships and numbers apply to the input/output planets as well.

We select a planet stage (ground or input/output) 3 in. high, two inches face width in the gear teeth and a 0.5 in high roller on each end. With a 0.005 in mesh backlash, (typical gear mesh practice), the shaft is constrained against tilting by the gear teeth to:

$$\begin{matrix}Constraint Against Tilt by Gear Teeth = \pm \frac{0.005 in}{2 in} \cdot \frac{360}{2 π} = \pm 0.1432394487827 deg & eq ( 22 ) \\ Constraint Against Tilt by Rollers = \pm \frac{0.005 in}{3 in} \cdot \frac{360}{2 π} = \pm 0.0954929658551 deg & eq ( 23 )\end{matrix}$$

The constraints are orthogonal to each other and permit rolling in a third, preferred, orthogonal direction. Movement in the fourth orthogonal direction is constrained by axial bearing contact between rollers and gear teeth as per normal gear-bearing action and, because there are no forces exerted in this direction. The tooth and roller constraints are stiff and strong. The gear teeth from a 0.625 in dia. Gear are strong as are the load bearing capabilities of 0.625 in dia rollers. And, there are four gear-bearing constraints in each of the two stages of the two-stage shift planets.
c. We will now examine the performance of the Twist Flexures (3a1b1).

We choose a flexure thickness of 0.010 in and a width of 1 in, with two flexures acting in parallel. This can resist a force before failure in shear [6][7].

0.010 in·1 in·2·55,000 psi=1100 lbs(or 4,400 lbs for four ground sgments) eq (24)

From FIG. 18, the maximum flexure twist required for curvature correction is

$$\begin{matrix}{C}_{G} θ = ( {C}_{G} + Δ {C}_{G} ) {θ}_{2} , \\ \frac{{C}_{G} θ}{{C}_{G} + Δ {C}_{G}} = {θ}_{2} & eq ( 25 ) \\ θ ( 1 - \frac{{C}_{G}}{{C}_{G} + Δ {C}_{G}} ) = θ - {θ}_{2} = Δ θ ( max ) & eq ( 26 ) \\ \begin{matrix}Δ θ = \frac{2 π}{8} \cdot ( 1 - \frac{3}{3 + 0.2} ) \\ = 0.0490873852123 rad \\ = 2.813 deg ( max )\end{matrix} & eq ( 27 )\end{matrix}$$

This is small angle bending which can be handled by flexures with low fatigue.

The length of the flexure bending in torsion is 1.5 in each. This requires 1.875 deg per inch twist which seems reasonable and acceptable. Still, the effective length of each bending flexure can be increased by using a flexure shape that doubles back on itself twice. In this case, each of the flexures (3a1b1) in FIG. 6 would assume an S shape where one open end of the S is attached to (3a1b), the other open end of the S is attached to (3a1b) and the turn-around section of the S is free and located near (3a1b). This modification would approximately triple the length of each of the torsion flexures and reduce maximum twist strain to 0.625 deg. per inch maximum twist strain. This would increase the number of cycles the system could endure. If flexure thickness and width are unchanged, the ability of the “S” flexures to withstand torque and force would be unchanged as well. The “S” shape flexures can be cut by wire EDM (electric discharge machining) with the spacing between adjacent legs of the “S”=0.020 inches (which adds an insignificant 0.040 inches to the radius of the ground ring system or 0.080 inches to the diameter of the ground ring system.

The return springs (labeled 3a1a2) in FIGS. 5 and 6 must allow a maximum radial displacement of 0.200 inches (for MA=−21), with a pre-displacement compression force sufficient to withstand the radial component of the forces acting on the gear teeth and roller bearing races of (3a1b) and (3a2b) translate and twist components for each of the ground ring segments (3a1 and 3a2).

6. SGGT Size

We will, now, estimate the over-all size of the SGGT. This will be a rough estimate, but will be useful in demonstrating its power density capabilities.
a. The Input/Output Stage
   1). Axial length approximately 3 inches
   2). Diameter of Output Ring approximately 6.75 inches
b. The Ground Stage
   1). The Ground Ring Segment System
      1a). Axial length approximately 3 inches
      2b). Diameter approximately 8.75 inches
   2). Moveable Ground Rings, Fixed Ground Rings, Electric Motors, Component Coupling Gear-Bearings, Shift system.
      1a). Axial length approximately 3 in (moveable ground rings)+3 in (fixed ground rings) (Other components listed in 2) above are contained within this axial length).
      2b). Diameter approximately 7.75 inches
c. Overall Size
   1) Axial Length approximately 12 inches
   2) Diameter
      a). Approximately 6.75 inches for 3 inches of axial length
      b) Approximately 8.75 inches for 3 inches of axial length
      c). Approximately 7.75 inches for 6 inches of axial length.
   3). Volume
      Approximately 571 cubic inches
   4). Approximately 98 lbs (volume with 60% steel fill factor).[7]
7. SGGT Performance

We will now estimate SGGT performance. We estimate the weakest point to be flexure shear at the twist flexures. This is limited to:

55,000 psi(steel shear strength)·0.010 in·1 in·2·0.5(safety factor)=1,100 lb-ft eq. (28)

Acting at a 3 inch radius, this provides 275 lb-ft available torque with 2/1 safety factor per engaged ground ring segments (1,100 lb-ft total for four segments). This is a very large number.

We will now estimate the efficiency of a SGGT.

We judge there to be five main load bearing moving elements; 1) the output ring, 2) the ground segments, 3) the gear-bearing rollers coupling the ground segments to the shaft, 4) the gear-bearing rollers coupling the shaft to the output ring and 5) the twist flexures allowing ground segment curvature connection. We neglect to input to the SGGT because the loads it bears are small compared to the other 5 elements. We also neglect the twist flexures because these do not have losses due to friction. The losses they have would be because of heating due to small angle bending and would be insignificant. The losses of 1) and 2) are spur gear losses with an efficiency estimated at 95%. The losses of 2) and 3) are a combination of roller bearing losses and spur gear losses. The spur gear efficiencies are estimated at 95% [8] and the roller bearing efficiencies are higher. We will estimate the overall efficiency of the gear-bearing rollers to be 95%. Thus, we estimate the over-all efficiency of a SGGT to be:

0.95⁴=0.8145=81.45% eq (29)

We will now discuss the speeder (FIG. 36) MA equation.

The speed increase is the product of a chain of four speed increases as per FIG. 36. From the standpoint of speed output, lossless conditions can be assumed. Losses will result in less output torque with higher efficiency, we have higher torque. Speed is unaffected.

So, speed increase is:

$$\frac{{ω}_{SPO}}{{ω}_{O}} = \frac{{R}_{2}}{{R}_{4 a 1}} \cdot \frac{{R}_{4 a 3}}{{R}_{4 b 1}} \qquad eq ( 30 )$$

In this speeder example, we seek a maximum over drive speed of 1.2 times input rpm (MA=0.833). We need to overcome a −21 speed reduction to achieve a 1.2 speed increase over drive so we need a speed increase of.

Speeder Ratio=21·1.2=25.2 eq (31)

We choose:

$$\frac{{R}_{2}}{{R}_{4 a 1}} = 5.04 , \\ {R}_{2} = 5.04 in , \\ {R}_{4 a 1} = 1 in \qquad eq ( 32 )$$

This results in:

$$\frac{{ω}_{SPO}}{{ω}_{O}} = 25.2 = 5.04 \cdot \frac{{R}_{4 a 3}}{{R}_{4 b 1}} , \\ \frac{{R}_{4 a 3}}{{R}_{4 b 1}} = 5 and {R}_{4 b 1} + {R}_{4 a 3} = 6.04 \qquad eq ( 33 )$$

Which, in turn, results in:

$${R}_{4 b 1} = \frac{6.04}{6} in = 1.0067 in \\ {R}_{4 a 3} = 6.04 in - \frac{6.04}{6} in = 5.0333 in \qquad eq ( 34 )$$

We will now discuss the expected efficiency of the speeder.

We have two gear tooth contacts in the speeder system that operate under significant load and we can, conservatively, expect 95% efficiency [8]

Eff=0.95²=0.9025=90.25% eq (35)

And, since torque out=torque in times efficiency, speed out will be unaffected, but torque will be slightly reduced.

8. SGGT Version with Reverse, Park and Forward

We will now discuss a version of the SGGT which is capable of continuously variable reverse and forward speeds, with stop in between. We will discuss a version which has predominantly forward speeds, with a limited range of reverse speeds and with a stop between. We begin by modifying the version of the SGGT with equal numbers of same pitch teeth in the Output and Ground ring gears. Our modification adds one tooth to the Output Ring and one tooth to the Input Sun, while leaving the Two Stage Variable Displacement Planets unchanged.

$$\begin{matrix}MA = \frac{{R}_{S} {ω}_{S}}{{R}_{R} {ω}_{RO}} = \frac{motion distance in}{motion distance out} & eq ( 36 ) \\ {R}_{S} {ω}_{S} = {R}_{S} {ω}_{PO} + {R}_{P} {ω}_{P} \\ ( matching tooth speeds at Sun ) & eq ( 37 ) \\ {R}_{RO} {ω}_{RO} = {ω}_{PO} {R}_{RO} - {ω}_{P} {R}_{P} \\ ( matching tooth speeds at Output Ring ) & eq ( 38 ) \\ {ω}_{PO} ( {R}_{RG} + Δ {R}_{R} ) - {ω}_{P} {R}_{P} = 0 \\ ( matching tooth speeds at Ground Ring ) & eq ( 39 ) \\ {ω}_{PO} = {ω}_{P} \frac{{R}_{P}}{{R}_{RG} + Δ {R}_{R}} \\ ( rearranging eq ( 39 ) & eq ( 40 ) \\ {R}_{S} {ω}_{S} = {R}_{S} {ω}_{P} \frac{{R}_{P}}{{R}_{RG} + Δ {R}_{R}} + {R}_{P} {ω}_{P} \\ ( substtuting eq ( 40 ) into eq ( 37 ) ) & eq ( 41 ) \\ {R}_{S} {ω}_{S} = {ω}_{P} {R}_{P} ( \frac{{R}_{S}}{{R}_{RG} + Δ {R}_{R}} + 1 ) \\ ( rearranging eq ( 41 ) & eq ( 42 ) \\ {R}_{RO} {ω}_{RO} = {ω}_{P} \frac{{R}_{P}}{{R}_{RG} + Δ {R}_{R}} {R}_{RO} - {ω}_{P} {R}_{P} \\ ( substituting eq ( 5 ) into eq ( 3 ) ) \\ So \text{:} & eq ( 43 ) \\ {R}_{RO} {ω}_{RO} = {ω}_{P} {R}_{P} ( \frac{{R}_{RO}}{{R}_{RG} + Δ {R}_{R}} - 1 ) \\ ( rearranging eq ( 8 ) & eq ( 44 ) \\ MA = \frac{( \frac{{R}_{S}}{{R}_{RG} + Δ {R}_{R}} + 1 )}{( \frac{{R}_{RO}}{{R}_{RG} + Δ {R}_{R}} - 1 )} \\ ( substituting eq ( 7 ) and eq ( 9 ) into eq ( 1 ) ) & eq ( 45 ) \\ MA = \frac{( {R}_{RG} + {R}_{S} + Δ {R}_{R} )}{( {R}_{RO} - {R}_{RG} - Δ {R}_{R} )} \\ ( rearranging eq ( 10 ) \\ {R}_{RG} = 3 in \\ {R}_{S} = 1.025 in \\ {R}_{RO} = 3.025 in \\ When Δ {R}_{R} = 0 & eq ( 46 ) \\ MA = \frac{( 3 in + 1.025 in )}{( 3.025 in - 3 in )} = 161 & eq ( 47 )\end{matrix}$$

The output from the speeder has:

$$\begin{matrix}MA = \frac{161}{25.2} = 6.4 \\ ( in reverse ) ( Reverse speed MA from ∞ to 6.4 ) & eq ( 48 ) \\ MA = ∞ when Δ {R}_{RG} = 0.025 in & eq ( 49 )\end{matrix}$$

From Table I,

$$\begin{matrix}Δ {R}_{P} ( Disp ) = 0.200 in max = Δ {R}_{RG} & eq ( 50 ) \\ \begin{matrix}MA = \frac{( 3 in + 1.025 in + 0.200 in )}{( 3.025 in - 3 in - 0.200 in )} \\ = - 24.143 ( Forward speed MA )\end{matrix} & eq ( 51 )\end{matrix}$$

The output from the speeder has:

$$MA = \frac{- 24.143}{25.2} = 0.958 \\ ( in forward ) ( Forward speed MA from ∞ to 0.958 ) \qquad eq ( 52 )$$

The performance of a reversible Gap Management CVT with fixed speeder output is on the order of:

MA=0.958 to ∞(forward)MA=6.4 to ∞(reverse)with stop(∞)between.

The lower MA has a higher output speed so the maximum forward speed is nearly one to one, almost an over-drive speed. The maximum reverse speed is more than adequate for most automotive applications where reverse speeds are typically slow for safety reasons. These results also suggest that our example SGGT with reverse, stop and forward capabilities can have a 1.2 to 1 overdrive gear (MA=0.833) by increasing the speeder increase to 31.56. This would also increase the reverse speed MA to 5.10. The increase in speeder performance would be accomplished with minor adjustments to the concept shown in FIG. 36. These are example values from a non-optimized design. Still, they demonstrate performance potential of the concept.

9. Summary of Expected Performance and Size

We estimate a SGGT, with fixed speeder output, will perform continuously variable output mechanical advantages −5.10 to ∞ (reverse) and ∞ to 0.833 (forward).

We estimate a torque capability of 2,880 lb-ft with a 2/1 safety factor.

We estimate the size as:
1) Axial Length approximately 12 inches
2) Diameter (approximately 6.75 inches for 3 inches of axial length, approximately 8.75 inches for 3 inches of axial length, approximately 7.75 inches for 6 inches of axial length)
3) Volume approximately 571 cubic inches
4) Weight approximately 98 lbs (estimating the volume is 60% filled with steel).

We estimate an overall efficiency of 73.5% (including the speeder). This includes 81.45% for the SGGT and 90.25% for the speeder.

### APPENDIX A

### Equilibrium Locking

In this appendix, we examine how equilibrium locking works and the equations that govern this behavior. We will focus on how a two-stage external gear works. These equations apply to two-stage external gear-bearings as well, but we will focus on how the gear teeth behave.

### I. Equilibrium Locking

The angle the stage 1 external gear turns to move from engagement to disengagement for each of n teeth is:

$$\frac{360}{n} = Δ {θ}_{1 max} \qquad eq ( 1 A )$$

The angle the stage 2 external gear turns to move from engagement to disengagement for each of n+P teeth is:

$$\frac{360}{n + P} = Δ {θ}_{2 max} \qquad eq ( 2 A )$$

The smaller angle is the angular limiting factor in correcting for equilibrium locking and the difference in the angles is:

$$\begin{matrix}\frac{360}{n} - \frac{360}{n + P} = 360 ( \frac{1}{n} - \frac{1}{n + P} ) \\ = 360 ( \frac{1}{n ( n + P )} ) \\ = Δ {θ}_{1 max} - Δ {θ}_{2 max}\end{matrix} \qquad eq ( 3 A )$$

In the back-drive situation, we have a back-drive force driving the stage 1 gear backwards, the ground reaction driving the stage 2 gear forward and no other forces present because the two-stage gear is free to rotate and translate, with the direction of translation typically either linear or along an arc. This means we have two gear lines of action operating in opposing directions while sharing a common center of rotation. But, these lines of action are also crossing different pitch circles along the shared centerline, so there is a displacement between them ΔL along this shared centerline (FIGS. 12A and 12B). So we have a moment arm and a back-drive torque and the two-stage planet responds by rotating and translating backwards. With two lines of action in different directions with a separation ΔL along the shared centerline, there must be a point off the centerline where they do intersect and we see this point in FIGS. 12A and 12B. When our back-rotating two-stage external gear rotates, the gear teeth in each stage rotate and translate. The lines of action go with the translating two-stage external gear so we can neglect translation and focus on the rotation. When a gear tooth in contact rotates, the contact location, on that tooth, rotates an arc distance with respect to the shared centerline and moves long the tooth involute surface. Since we have opposite forces operating on opposite tooth involute surfaces and a common rotation angle, the contact location on one tooth is moving down as the contact surface on the other tooth is moving up and both teeth are rotating arc distances in the same direction. These movements are acting together to align the opposing forces with the crossover point on the opposing lines of action. When this point is reached, we are at the equilibrium point and back-rotation stops. We are at equilibrium locking.

The overlap in terms of back-drive moment arm is given as:

0.5·(PD₂−PD₁)=maximum backdrive moment arm eq (4A)

From the definition of diametral pitch, we have:

$$\begin{matrix}0.5 \cdot ( \frac{{n}_{2}}{DP 2} - \frac{{n}_{1}}{DP 1} ) = maximum backdrive moment arm \\ Or \text{:} & eq ( 5 A ) \\ \frac{0.5 \cdot ( {n}_{2} - {n}_{2} )}{DP} = maximum backdrive moment \\ arm ( DP 2 = DP 1 = DP ) & eq ( 6 A )\end{matrix}$$

The two-stage planet will turn to eliminate this moment arm and the rotation required to accomplish this will require involute arc distance on each contact tooth surface, so a smaller moment arm is better for equilibrium locking.

$$\begin{matrix}\frac{2}{DP} = working depth \\ [ 9 ] [ Cage Gear \& Machine , LLC \text{:} American Standard \\ Involute System Full Depth Tooth Calculations ] & eq ( 7 A ) \\ \frac{2}{DP} - \frac{( {n}_{2} - {n}_{1} )}{2 DP} = \frac{4 + {n}_{1} - {n}_{2}}{2 DP} \\ working depth available for locking & eq ( 8 A )\end{matrix}$$

We estimate that rotation angle available because of this available working depth is:

$$\begin{matrix}\frac{working depth available for locking}{total working depth} \cdot {Δθ}_{2 max} = angle available for locking \\ Substituting & eq ( 9 A ) \\ ( \frac{4 + {n}_{1} - {n}_{2}}{2 DP} ) \cdot \frac{DP}{2} \cdot \frac{360}{n + P} = \frac{( 4 + {n}_{1} - {n}_{2} )}{4} \cdot \frac{360}{n + P} = Δ {θ}_{L} & eq ( 10 A )\end{matrix}$$

Where Δθ_{L} is the angle available for locking.

The above narrative has been made based on FIGS. 12A and 12B, but these figures represent one angular position among many for a two-stage external gear. In this two-stage external gear, both stages have the same diametral pitch, but different pitch diameters and, hence, different numbers of teeth in the first and second stages. When we index the two-stage external gear such that the stage 1 and stage 2 gear teeth are in angular alignment at θ=0, we have the case shown in FIGS. 12A and 12B. However, as we examine the gear teeth alignment at different angles, we find the teeth misalign with each increasingly, up to 180 degrees and decreasingly from 180 degrees to 360 degrees. At some angle, the misalignment in the stage 1 and stage 2 teeth reaches a maximum of exactly out of phase as per FIGS. 12B and 12C. In this instance the ΔL moment arm and action and reaction lines remain the same, but we have the back-drive and reaction forces operating on teeth that are spread apart. So, we get back-rolling to equilibrium locking as in the alignment case. However, in the maximum misalignment case, we may run out of involute arc on one of the spread teeth and contact will be picked up by the next available tooth. We design the system with a gear contact ratio of 1.6 so we always have at least one tooth in contact at all times, with 1.6 teeth on average, so equilibrium locking at maximum phase difference functions much the same as in the alignment case. We conclude that equilibrium locking will hold for other misalignment angles as well.

### II. Limits to Equilibrium Locking

The limit for equilibrium locking occurs when the addendum of the smaller diameter stage is less than the addendum minus the working depth of the larger diameter stage. Under these conditions, there is always moment arm for the back-drive and reaction forces to act on and the two-stage planet back-spins throughout the entire engagement cycle for each tooth. We consider the case where the diametral pitch for stage 2 equals the diametral pitch for stage 1.

For the back-drive case, the addendum of planet stage 1 must pass under the addendum of planet stage 2 minus the working depth of planet stage 2 or:

PD₂−PD₁>2·Working depth(or 4·Addendum) eq (11A)

Which can be expressed as:

$$\frac{{n}_{2}}{DP 2} - \frac{{n}_{1}}{DP 1} > \frac{4}{DP 2} \qquad eq ( 12 A )$$

Where:

DP2=DP1=DP eq (13A)

From definition of pitch diameter as it relates to diametral pitch:

$$\begin{matrix}\frac{{n}_{2}}{DP 2} = {PD}_{2} & eq ( 14 A ) \\ \frac{{n}_{1}}{DP 1} = {PD}_{1} & eq ( 15 A ) \\ 4 \cdot \frac{1}{DP 2} = 4 \cdot Addendum 2 \\ So \text{:} & eq ( 16 A ) \\ \frac{{n}_{2}}{DP} - \frac{{n}_{1}}{DP} > \frac{4}{DP} or {n}_{2} - {n}_{1} > 4 \\ And \text{:} & eq ( 17 A ) \\ PD 2 = \frac{{n}_{2}}{{n}_{1}} PD 1 & eq ( 18 A )\end{matrix}$$

### III. Example Cases

We will, now, examine some example cases to see how equilibrium locking would work in practice.

a. Case 1.

We examine the case where, n₁=20, n₂=21, PD1=2 in and PD2=2.1 in:

$$\begin{matrix}\begin{matrix}\frac{360 °}{20} = 18 ° & ( for planet stage 1 )\end{matrix} & eq ( 19 A ) \\ \begin{matrix}\frac{360 °}{21} = 17 \text{,} 143 ° & ( for planet stage 2 )\end{matrix} & eq ( 20 A )\end{matrix}$$

The amount of rotation available to eliminate maximum back-drive moment arm is the stage 2 number 17,143° because it is the smaller value.

$$\begin{matrix}\frac{0.5 \cdot ( {n}_{2} - {n}_{2} )}{DP} = maximum backdrive moment \\ arm ( DP 2 = DP 1 = DP ) & eq ( 21 A ) \\ \frac{0.5 \cdot ( 21 - 20 )}{10} = Δ L = 0.050 in ( maximum backdrive \\ moment arm ) & eq ( 22 A ) \\ \frac{( 4 + {n}_{1} - {n}_{2} )}{4} \cdot \frac{360}{n + P} = Δ {θ}_{L} ( available for locking ) & eq ( 23 A ) \\ \frac{( 4 + 20 - 21 )}{4} \cdot \frac{360}{21} = Δ {θ}_{L} = 12.857 ° ( available for \\ locking ) & eq ( 24 A ) \\ \frac{4 + {n}_{1} - {n}_{2}}{2 DP} workinng depth available for locking & eq ( 25 A ) \\ \frac{4 + 20 - 21}{20} = 0.150 in workinng depth available \\ for locking & eq ( 26 A ) \\ \frac{0.050}{0.150} \cdot 12.857 ° = 4.286 ° used in rolling to eliminate \\ 0.050 in moment arm & eq ( 27 A )\end{matrix}$$

This leaves a reserve rolling capability of 8.5714°, which is sufficient. With n₂=21 and n₁=20, the teeth are directly above and below each other as in the FIGS. 12A and 12B orientation and are exactly out of phase diametrically opposite as shown in the FIGS. 12C and 12D orientation. In both orientations, there is sufficient reserve rolling capability to perform equilibrium locking. At other points along the two-stage gear perimeter, the alignment between upper and lower teeth shifts progressively between the fully aligned and exactly out of alignment orientations. We design so the gear teeth contact ratio is 1.6 or better, so there is an average of 1.6 teeth engaged at any instant and there is always at least one tooth engaged and often two. So, if during equilibrium locking one tooth rolls out of contact, another will be in contact to replace it.

b. Case 2

We, now, examine the case where, n₁=20, n₂=22, PD1=2 in and PD2=2.2 in.

We have:

$$\begin{matrix}\begin{matrix}\frac{360 °}{20} = 18 ° & ( for planet stage 1 )\end{matrix} \\ And \text{:} & eq ( 28 A ) \\ \begin{matrix}\frac{360 °}{22} = 16.364 ° & ( for planet stage 2 )\end{matrix} & eq ( 29 A )\end{matrix}$$

We know:

$$\begin{matrix}\frac{0.5 \cdot ( {n}_{2} - {n}_{1} )}{DP} = maximum backdrive moment \\ arm ( DP 2 = DP 1 = DP ) \\ So \text{:} & eq ( 30 A ) \\ \frac{0.5 \cdot ( 22 - 20 )}{10} = Δ L = 0.100 in \\ ( maximum backdrive moment arm ) & eq ( 31 A )\end{matrix}$$

We also know:

$$\begin{matrix}\frac{2}{DP} - \frac{( {n}_{2} - {n}_{1} )}{2 DP} = \frac{4 + {n}_{1} - {n}_{2}}{2 DP} \\ working depth available for locking \\ So \text{:} & from eq ( 8 A ) \\ \frac{2}{2 \cdot 10} = 0.100 in \\ working depth available for locking & eq ( 32 A )\end{matrix}$$

Looking at this from an angle perspective, we have:

$$\begin{matrix}( \frac{4 + {n}_{1} - {n}_{2}}{2 DP} ) \cdot \frac{DP}{2} \cdot \frac{360}{n + P} = \frac{( 4 + {n}_{1} - {n}_{2} )}{4} \cdot \frac{360}{n + P} = {Δθ}_{L} \\ And \text{:} & from eq ( 10 A ) \\ \frac{2}{4} \cdot \frac{360}{22} = {Δθ}_{L} = 8.162 ° ( available for locking ) & eq ( 33 A )\end{matrix}$$

The results of eq (31A), eq (32A) and eq (33A) suggest that the available working depth and reserve Δθ_{L} are just enough to back-roll out ΔL=0.100 in, with zero reserve locking capability. Taking into account, our 1.6 contact ratio, we have 0.6 teeth in reserve so the system will equilibrium lock. In practice, we expect there will be times when the two-stage outer gear back-rolls past one of the engaged teeth and engages another to complete the equilibrium locking and other times where this will not be necessary.

c. Case 3

We, now, examine the case where, n₁=20, n₂=23, PD1=2 in and PD2=2.3 in.

We have:

$$\begin{matrix}\begin{matrix}\frac{360 °}{20} = 18 ° & ( for planet stage 1 )\end{matrix} \\ And \text{:} & eq ( 34 A ) \\ \begin{matrix}\frac{360 °}{23} = 15.652 ° & ( for planet stage 2 )\end{matrix} & eq ( 35 A )\end{matrix}$$

We know:

$$\begin{matrix}\frac{0.5 \cdot ( {n}_{2} - {n}_{1} )}{DP} = maximum backdrive moment \\ arm ( DP 2 = DP 1 = DP ) \\ So \text{:} & eq ( 36 A ) \\ \frac{0.5 \cdot ( 23 - 20 )}{10} = Δ L = 0.150 in \\ ( maximum backdrive moment arm ) & eq ( 37 A )\end{matrix}$$

We also know:

$$\begin{matrix}\frac{2}{DP} - \frac{( {n}_{2} - {n}_{1} )}{2 DP} = \frac{4 + {n}_{1} - {n}_{2}}{2 DP} \\ working depth available for locking \\ So \text{:} & from eq ( 8 A ) \\ \frac{1}{2 \cdot 10} = 0.050 in \\ working depth available for locking & eq ( 38 A )\end{matrix}$$

Looking at this from an angle perspective, we have:

$$\begin{matrix}( \frac{4 + {n}_{1} - {n}_{2}}{2 DP} ) \cdot \frac{DP}{2} \cdot \frac{360}{n + P} = \frac{( 4 + {n}_{1} - {n}_{2} )}{4} \cdot \frac{360}{n + P} = {Δθ}_{L} \\ And \text{:} & from eq ( 10 A ) \\ \frac{1}{4} \cdot \frac{360}{23} = {Δθ}_{L} = 3.913 ° ( available for locking ) & eq ( 39 A )\end{matrix}$$

The results of eq (37A), eq (38A) and eq (39A) suggest that the available working depth and reserve Δθ_{L} are not enough to back-roll out ΔL=0.150 in, so must see if the reserve capability afforded by having a contact ratio of 1.6 will help. When we factor in the 1.6 contact ratio, we find an effective Δθ_{L}=6.261° and 0.080 in working depth available to back-roll out our ΔL=0.150 in. We conclude the system will not equilibrium lock, but rather it will back-drive. A final cautionary note: The equations that were used are approximations and the results of a high fidelity simulation might provide different results for Case 3. But, it seems certain that Case 1 will equilibrium lock and highly likely that Case 2 will equilibrium lock as well.

Having thus shown and described what is at present considered to be the preferred embodiment of the invention, it should be noted that the same has been made by way of illustration and not limitation. Accordingly, all modifications, alterations and changes coming from within the spirit and scope of the invention as set forth in the appended claims are herein to be included.

### REFERENCES

1. Vranish, J. M., Gear Bearings, U.S. Pat. No. 6,626,792, Sep. 30, 2003.
2. NASA presentation: Gear-Bearing Technology by John Vranish, Technology Transfer Expo and Conference Mar. 3-6, 2003, contact John Vranish (jmvranish@hotmail.com) or Darryl R. Mitchell, Goddard Space Flight Center for a copy.
3. Mechanical Engineering, August 2002, pp. 47-49. [Article (by Paul Sharke) entitled The start of a new movement A NASA invention is one of several poised on the brink of commercialization. But it needs outside help to get there.] Discusses Gear-Bearing technology and how to commercialize same. A rotating Gear-Bearing transmission icon on on-line magazine links directly to article. Mechanical Engineering is an official publication of ASME (American Society of Mechanical Engineers).
4. Weinberg, Brian (Brookline, Mass.), Mavroidas, Constantinos (Arlington, Mass.), Vranish, John M. (Crofton, Md.), Gear Bearing Drive, U.S. Pat. No. 8,016,893 Sep. 13, 2011.
5. Roll-Lock Private Papers of John M. Vranish. These private papers will be the basis for the specification of a separate Roll-Lock patent application because it has applications beyond the Gap Management CVT.
6. Mechanics of Materials, Beer, Ferdinand P. and E. Russell Johnston, Jr., p. 584 Appendix B (STEEL: quenched and tempered alloy ASTM-A514 Shear yield strength=55,000 psi) McGraw-Hill, Inc., copyright 1981, ISBN 0-07-004284-5.
7. Ibid., shows steel has a density of 0.284 lbs per cubic inch
8. Search: gear efficiency: click on Gears-Gear Efficiency-RoyMech Index page: find Efficiency Range 98% to 99% for spur and helical gears listed in table. (Searched by JMV May 10, 2012) 95% value is used to be conservative.
9. Search Full Depth Gear Calculations, click on American Standard Involute System-Full Depth Tooth Calculations, read diagrams and table that defines terms and provides design equations. A calculator is also provided. (jmv Jun. 3, 2012).

What is claimed is:

1. A two-stage epicyclical planetary gear system capable of providing a continuously variable angular velocity and torque output, from a fixed angular velocity and torque input over a shift range continuum, wherein said two-stage epicyclical planetary gear system is configured with a fixed radius input gear, a fixed radius output gear, a variable radius ground gear, multiple two-stage variable displacement planets and a shift system, wherewith said input gear operates on the input/output stage planets of said two-stage variable displacement planets, said shift system operates on the ground stage planets of said two-stage variable displacement planets, said ground stage planets respond by each moving radially, said ground gear responds by, in effect expanding or contracting radially and the rotation and orbit angular velocities of the two-stage variable displacement planets are changed, whereby the output angular velocity and torque are changed, wherein said displacement and expansion or contraction occurs in continuum, over a shift range, whereby said shift two-stage epicyclical planetary system is capable of a continuously variable angular velocity and torque output from a fixed angular velocity and torque input, wherein said ground gear system can be designed to provide different continuum shift ranges, including a continuum shift range from maximum reverse angular speed to stop to maximum forward angular speed, wherein a fixed ratio speed enhancement gear system can be added to the output of said shift two-stage epicyclical planetary gear system to increase the entire angular velocity range by a fixed multiplication factor, wherein anti-friction, rolling contacts are used throughout to transfer torque and power with high efficiency and to maintain proper alignment and orientation between parts and components operating under loads with precision and high efficiency, said shift two-stage epicyclical planetary gear system comprising:
a fixed dimension input gear and an output gear;
a ground gear system, wherein a ground gear is segmented into multiple gear segments, with twice as many gear segments as there are said two-stage variable displacement planets, wherein each segment, can be moved radially inwards and outward, whereby half of said gear segments are displaced radially at any instant by contact with said two-stage variable displacement planets and the remaining half of said gear segments are radially displaced by gear segment to gear segment contact, whereby gaps form between said gear segments, whereby the effective ground gear radius is changed, but with gaps between said gear segments and errors in the curvature of each said gear segment, wherein half the said gear segments are free to move and close the gaps between adjacent gear segments while load-bearing gear segments remain stationary, whereby energy losses are minimized, wherein each said gear segment rotates slightly in compliance with a contacting two-stage variable displacement planet, whereby gear segment curvature errors are corrected, wherein the process of closing said gaps and rotating to correct said curvature errors, can be repeated in a cyclical manner, whereby continuous operation for extended periods of time can be performed, wherein each said gear segment can withstand large torque when stationary, wherein said ground gear system can be designed to provide different shift range continuums for the same input gear, output gear and multiple two-stage variable displacement planets, including a continuously variable shift range from maximum reverse angular velocity to stop to maximum forward angular velocity,
multiple two-stage variable displacement planets,
wherein, each planet rolls and orbits at the same angular velocities, wherein the two stages in each said planet also rotate and orbit at the same angular velocities and each said planet stage is involved in transferring angular motion and torque between said input sun gear, said output internal gear and said ground internal gear system, wherein each said planet ground stage can be displaced radially, whereby each said ground internal gear section is also displaced radially, whereas said input sun gear, said output internal gear and said input/output stage planet are not displaced, wherein shifting is in continuum over a shift range and said shifting can be performed during operation, under load, while producing output torque;
a radially expanding and contracting shift system,
wherein a linear actuator system applies force along the rotation axis of a cylindrical structure, whereby said structure expands or contracts radially, while continuously maintaining contact with the ground stages of said variable planets and displacing said ground stages radially, wherein said cylindrical structure rotates non-slip with rotating and orbiting said two-stage variable displacement planet, wherein said cylindrical structure rotates using anti-friction rolling contacts, decoupled from said linear actuator in rotation, but coupled to apply linear force along the rotation axis of said cylindrical structure, whereby radial force is uniformly applied to said cylindrical structure, wherein said axial linear force is applied equal and opposite, whereby radial forces add, while axial forces are self-cancelling and said cylindrical structure moves radially without transferring axial stress forces to said two-stage variable displacement planets;
a motion control system, with electric motors to move the ground ring internal gear sections and drive the linear actuator.

2. A ground gear system according to claim 1, wherein a first set of alternating ground gear segments are attached to a first moveable ground ring and a second set of alternating ground gear sections are attached to a second moveable ground ring, whereby said first set of ground gear segments can be moved or held stationary as a group and said second set of ground gear segments can be moved or held stationary as a group, wherein said moveable ground gear segments move and are held stationary independent of each other.

3. Ground gear segments according to claim 2 wherein each said ground gear segment has a housing, a translate and twist gear segment, gear-bearing rollers coupling said translate and twist gear segment to said housing and a connection structure connecting said housing to either a first said moving ground ring or to a second said moving ground ring, whereby said translate and twist gear segment can engage the gear teeth of said two-stage planets, can translate radially to accommodate the radial shifting of said two-stage variable displacement planets and can twist to correct curvature errors caused by its said radial translation.

4. Each translate and twist gear segment according to claim 3, with a gear-bearing section, two identical parallel twist flexures and two identical linear gear-bearing structures, therein, wherein the gear-bearing section is attached to the parallel twist flexures along the outer surface of the internal gear section and along the common end of the two identical parallel twist flexures, wherein each of two identical said linear gear-bearing structures is attached to a twist flexure remote end, with said linear gear-bearings facing each other and aligned to each other in the direction of translation, wherein said internal gear-bearing section has a center internal gear with roller bearing races above and below, whereby proper internal gear alignment is maintained during translation and torque transfer, wherein said linear gear-bearings have a linear center roller bearing race with a linear helical gear on each side, whereby a linear cross helical gear-bearing is formed.

5. A housing structure according to claim 4, with a translate and twist gear segment, interface, a return spring and a structure attaching said housing structure to one of the two said moveable ground rings, therein, wherein said translate and twist gear interface is a rectangular structure, with linear gear-bearings on opposite faces of said interface, wherein said interface linear gear-bearings are oriented in the direction of translation, using crossed helical gear teeth, wherein each said interface linear gear-bearing faces and is aligned with a similarly configured said linear gear-bearing on the translate structures of said translate and twist gear section.

6. Coupling gear-bearings according to claim 5 wherein a center roller is between crossed helical gears to form an external crossed helical gear-bearing, wherein said coupling gear-bearing meshes with the linear gear-bearings in said housing interface structure and with said linear gear-bearings in said translate and twist internal gear section.

7. A ground gear segment according to claim 6, wherein said translate and twist gear segment translates using said anti-friction coupling gear-bearings, but is constrained against torque by said crossed helical gears, whereby small angle twisting for said error curvature correction is constrained to said twist flexure twisting, whereby said curvature error is corrected, wherein said return spring maintains contact between said ground gear-bearings and said planet ground stage gear-bearings throughout the said shift range, whereby roller to roller bearing race contacts maintain proper alignment, curvature correction and positioning for proper gear action throughout each said ground gear segment.

8. A ground gear system according to claim 2, wherein said first moveable ground ring and said first fixed ground ring are constructed as internal gear-bearings, wherein said first moveable ground internal gear-bearing and said first fixed ground internal gear-bearing are coupled by a first set of recirculating two-stage gear-bearing planets, wherein said second moveable ground ring and said second fixed ground ring are constructed as external gear-bearings, wherein said second moveable ground gear-bearing and said second fixed ground gear-bearing are coupled by a second set of recirculating two-stage gear-bearing planets, wherein a drive external gear-bearing ring couples the ground stages of said first set of two-stage gear-bearing planets together, whereby when said drive external gear-bearing ring rotates, said first set of recirculating gear-bearing planets rotate and orbit together, whereby said first moveable ground ring rotates with respect to said fixed ground ring with mechanical advantage, wherein a drive internal gear-bearing ring couples the ground stages of said second set of two-stage gear-bearing planets together, whereby when said drive internal gear-bearing ring rotates, said second set of recirculating gear-bearing planets rotate and orbit together, whereby said second moveable ground ring rotates with respect to said second fixed ground ring with mechanical advantage, wherein the output stages of said first set of recirculating gear-bearing planets are constrained radially by a first retaining ring, whereby said first retaining ring is free to rotate to match the contact tooth speeds of said first set of recirculating planets, wherein the output stages of said second set of recirculating gear-bearing planets are constrained radially by a second retaining ring, whereby said second retaining ring is free to rotate to match the contact tooth speeds of said second set of recirculating planets, wherein said first and second moveable and fixed ground rings are concentric with the center of rotation of said input gear.

9. A ground ring system according to claim 8, wherein said first and second set of two-stage gear-bearing planet are each constructed with a ground stage roller on one end adjacent to a ground stage gear adjacent to an output stage gear adjacent to an output stage roller on the opposite end, wherein said first moveable ground ring internal gear-bearing is constructed with a roller bearing race on the end furthest from said first fixed ground ring internal gear bearing and an internal gear on the end nearest said first fixed ground ring internal gear-bearing, wherein said first fixed ground ring internal gear-bearing is constructed with an internal gear on the end nearest said first moveable ground ring and a roller bearing race further away, whereby said roller bearing races are maximally separated and radial tilt of said first set of recirculating two-stage gear-bearing planets is minimized, wherein said second moveable ground ring external gear-bearing is constructed with a roller bearing race on the end furthest from said second fixed ground ring external gear bearing and an external gear on the end nearest said first fixed ground ring external gear-bearing, wherein said second fixed ground ring external gear-bearing is constructed with an external gear on the end nearest said first moveable ground ring and a roller bearing race further away, whereby said roller bearing races are maximally separated and radial tilt of said second set of recirculating two-stage gear-bearing planets is minimized, wherein twist between said two-stage planet output stage and input stage is constrained by the backlash clearance between the meshing teeth, whereby maximizing said planet stage tooth face width and minimizing mesh backlash, minimizes said twist angle and maximizes planet tooth strength and endurance, said constraints against tilt and twist are anti-friction, rolling contacts and are very efficient.

10. A drive and equilibrium braking system for moving a first structure with respect to a second structure using anti-friction rolling contacts with mechanical advantage and for locking said first structure in place with respect to said second structure with power off, using anti-friction contacts rolling to an equilibrium point, wherein said movement and equilibrium locking are constrained to be bi-directional, said system comprising:
a said first structure with a geared contact surface therein, a said second structure with a geared contact surface therein, one or more two-stage external gears, a drive structure with a geared contact surface therein and an idler structure, wherein said first object, said second object, said drive structure and said idler structure move parallel to each other; wherein said second object is fixed to mechanical ground and is meshed with the ground stage of each said two-stage external gear and said first object is meshed with the output stage of each said two-stage external gear, wherein said drive structure is meshed with the said ground stage of each said two-stage external gear and said idler structure is maintained in anti-friction rolling contact with the said output stage of each said two-stage external gear (alternately said drive structure is meshed with said output stage and said idler structure is maintained in anti-friction rolling contact with said ground stage), wherein, said drive structure and said idler structure are on one side of said two-stage external gears, diametrically opposite said ground and output structures, wherein said two-stage external gears both rotate and move in displacement;
an equilibrium locking system,
wherein said first external gear of each two-stage external gear is back-driven by said first geared structure while said second external gear is subjected to reaction forces in the opposite direction, wherein said reaction forces are supplied by said second geared structure fixed to mechanical ground, wherein said first external gear is constructed with a pitch diameter slightly different from said second external gear, whereby the lines of action of said external gears are in opposite directions with one line of action passing over the other to form a net small moment arm between said action and reaction forces, whereby said two-stage planets rotate and moves in displacement, down one said line of action and up the other said line of action until said two-stage external gears simultaneously reach the intersection point of the opposing lines of action, whereby equilibrium is reached and rotation and displacement stop, wherein the shared arc of action and resulting said two-stage planet displacement is made sufficient to reach equilibrium by designing said back-drive moment arm sufficiently small and choosing a sufficiently large diametral pitch for said two-stage external gears;
said drive and equilibrium braking system,
wherein the difference between said output and ground external gears can be chosen to a practical range wherein, high output mechanical advantage and low output speed can be balanced against lower mechanical advantage and higher output speed.

11. A drive and equilibrium braking system according to claim 10, wherein said drive structure, said first object, said second object and said two-stage external gears are gear-bearings; wherein said idler structure is optionally either a gear-bearing or a roller.

12. A gear-bearing drive and equilibrium braking system according to claim 11, wherein said drive structure is a gear-bearing ring, said first structure is a gear-bearing ring, said second structure is a gear-bearing that is mechanically grounded, said two-stage external gears are two-stage gear-bearings and said idler structure is either a gear-bearing ring or a roller ring.

13. An internal gear-bearing epicyclical planetary transmission according to claim 12, wherein said first structure is an internal gear-bearing output ring, said second structure is an internal gear-bearing ground ring, wherein said drive structure is an external gear-bearing drive ring, wherein said idler structure is optionally either a roller ring contacting on its outer surface or an external gear-bearing ring, wherein said two-stage gear-bearings are recirculating, whereby an internal gear-bearing epicyclical planetary transmission is formed, whereby said epicyclical planetary transmission is equilibrium braking with high mechanical advantage drive, wherein said gear-bearing drive ring is coupled to ground stages of said two-stage gear-bearing planets at the ground stages and said idler structure is coupled to the output stages of said two-stage gear-bearing planets, wherein, optionally, said gear-bearing drive ring is coupled to said gear-bearing two-stage planets at the output stage planets and said idler structure is coupled to the ground stage planets.

14. An external gear-bearing epicyclical planetary transmission according to claim 12, wherein said first structure is an external gear-bearing output sun, wherein said second structure is an external gear-bearing ground sun, wherein said drive structure is an internal gear-bearing drive ring, wherein said idler structure is optionally configured as either a roller ring contacting on its inner surface or an internal gear-bearing ring, wherein said two-stage gear-bearings are recirculating, whereby a gear-bearing external epicyclical planetary transmission is formed, whereby said epicyclical planetary transmission is equilibrium braking with high mechanical advantage drive, wherein said gear-bearing drive ring is coupled to ground stages of said two-stage gear-bearing planets at the ground stages and said idler structure is coupled to the output stages of said two-stage gear-bearing planets, wherein, optionally, said gear-bearing drive ring is coupled to said gear-bearing two-stage planets at the output stage planets and said idler structure is coupled to the ground stage planets.

15. A linear gear-bearing transmission according to claim 12, wherein said first structure is linear gear-bearing output rack, wherein said second structure is a linear gear-bearing fixed to mechanical ground, wherein said drive structure and said idler structure are each configured as linear gear-bearings, wherein said ground linear gear-bearing is coupled to the ground stage of said two-stage external gear-bearings and said output linear gear-bearing is coupled to the output stage of said two-stage external gear-bearings on the same side as said ground linear gear-bearing, wherein said drive linear gear-bearing is coupled to said ground stage of said two-stage external gear-bearings, diametrically opposite said ground linear gear-bearing, wherein said idler linear gear-bearing is coupled to said output stage of said two-stage external gear bearings, diametrically opposite said output linear gear-bearings, wherein, optionally, said drive linear gear-bearing is coupled to the output stage of said two-stage gear-bearings and said idler linear gear-bearing is coupled to the ground stage of said two-stage gear-bearings, wherein back and forth linear movement of said drive linear gear-bearing rolls the said two-stage external gear-bearings, which, in turn, react against said ground linear gear-bearing and drive said output linear gear-bearing back and forth with mechanical advantage and brakes said output linear-bearing with said equilibrium braking, wherein anti-friction rolling contacts are used throughout.

16. A concentric pair of ground ring systems according to claim 9, wherein said inner ground ring system is an internal two-stage epicyclical gear-bearing planetary transmission and said outer ground ring system is an external two-stage epicyclical gear-bearing planetary transmission.

17. A concentric pair of ground ring systems according to claim 16, wherein said drive and equilibrium braking system is used in each said ground ring system, whereby each said moveable ground ring can be independently, moved, with high mechanical advantage and anti-friction efficiency and stopped with said equilibrium braking, whereby said equilibrium braking system holds with power off.

18. A shift system according to claim 1, with a shift drive system, shift screw slide system and radial expansion contraction interface structure, therein, whereby said shift drive system powers said shift screw slide system, whereby said shift screw slide system moves along the axis of said radial expansion contraction interface structure, whereby said radial expansion contraction interface structure expands or contracts according to the direction the screw slide moves, whereby the radial position of the ground planet of each said two-stage shift planet is determined.

19. A shift screw slide system according to claim 18 with a shift screw, inner nut, outer nut, inner nut spline, input drive gear and input drive gear spline therein, with said outer nut fixed to said shift screw and said inner nut threaded on said shift screw therein, with a said shift screw spline and mechanical ground spline therein, with said inner nut coupled to an outer, concentric ring by recirculating anti-friction bearings and said outer nut coupled to an outer, concentric ring by recirculating anti-friction bearings therein, with said inner nut concentric ring and said outer nut concentric ring each tapered, with said tapers mirror images of each other, therein, whereby when said input drive gear is rotated, said input drive gear spline engages said inner nut spline, whereby said inner nut turns with respect to said shift screw, whereby said shift screw is constrained from rotating by said shift screw spline and said mechanical ground spline, whereby said inner and outer nuts move linearly with respect to each other and the shift screw slides with respect to mechanical ground, slide direction depending on the rotation direction of said input drive gear, whereby said inner and outer concentric ring tapers engage matching tapers in said radial expansion contraction interface structure, whereby said interface structure is radially expanded or contracted, whereby said concentric rings can rotate with said interface structure, while said shift screw does not rotate and said shift screw is self-centering with respect to said interface structure as it exerts radial forces on said interface structure.

20. A radial expansion contraction interface structure according to claim 19 wherein a cylindrical surface is followed radially inward by a connection structure at its axial midpoint, separating two cylindrical spaces, one space on each end, followed radially inward by a tapered inner structure, whose tapers mate with the tapers of the said concentric rings, followed radially inward by a cylindrical open space, wherein the entire said interface structure is constructed as a closed set of flexures connected in series to form a cylindrical spring, with said flexures angled with respect to said cylindrical axis, with said flexure angle sufficiently large to prevent said flexure from slipping between said planet ground stage gear, with axial length sufficient to achieve required radial expansion contraction range, wherein said tapered inner structure and said connection structure are constructed of multiple separated parts which do not significantly contribute to said spring action, wherein said multiple separated parts are each at the same angle as said cylindrical spring, whereby said shift screw can fit through said hollow center and said concentric rings can operate on said interior structure with matching taper contacts, whereby and the outer cylindrical surface of said interface structure can radially expand by flexure elastic bending as said drive gear rotates in one direction and can spring return as said drive gear rotates in the opposite direction.

21. Two-stage variable displacement planets according to claim 1, wherein said ground stage planet and said input/output stage planet have the same diameter and the same gear pitch, wherein each said stage planet is a gear-bearing with rollers on each end, wherein said ground stage planet gear-bearings mesh with said ground ring section internal gear-bearings, said input/output stage gear-bearings mesh with said input gear-bearings and said output ring internal gear-bearings, whereby said ground stage planet gear bearing rollers can contact and push back against said ground ring section roller bearing races, thereby maintaining proper gear mesh and torque transfer and providing curvature correction for said ground ring segments.

22. A two-stage variable displacement planet according to claim 21 with a ground stage planet, an input/output stage planet, a planet interface shaft and anti-friction coupling gear-bearing rollers, therein, wherein said planet interface shaft has an input/output rectangular shaft and a ground rectangular shaft, with a separator structure between, wherein said input/output and ground shafts are relatively wide and long and are at right angles to each other, wherein each of their opposite surfaces are in the form of a linear gear-bearing with roller bearing races on each of the shaft ends and gear racks oriented for rolling in the direction of shaft width, wherein said input/output and ground stage planets are each constructed with an identical through slot centered at the center of rotation, with the surfaces of each slot in the form of a linear gear-bearing with upper and lower roller-bearing races on each and with rack gears oriented for rolling in the direction slot length, wherein said anti-friction coupling gear-bearing rollers have rollers on their ends and mesh with said gear-bearing slots and said planet gear-bearing interface shafts, wherein each said two-stage shift planet is assembled with said gear-bearing rollers coupling said ground stage planet to said input/output stage planet through said gear-bearing input/output shaft and said ground shaft, whereby said ground stage gear-bearing can be shifted radially while said input/output stage planet is maintained at a fixed radius.

23. A two-stage variable displacement planet according to claim 22 whereby said ground stage planet is shifted and displaced in a radial direction with respect to said input/output planet by a combination of Cartesian coordinate translations of said planet interface shaft right angle input/output and ground shafts, therein, wherein each said shaft moves a coordinate distance with the vector sum of these distances providing the radial displacement distance, wherein said gear-bearing coupling rollers roll with each shaft translation a distance of half the shaft translation, whereby said planet interface shaft and said coupling gear-bearing rollers are continuously adjusting their positions as a radially shifted said two-stage shift planet rotates and orbits, whereby said planet interface shaft rotates about a center midway between the rotation centers of said input/output stage planet and said ground stage planet and said coupling gear-bearing planets rotate with said planets interface shaft while simultaneously translating back and forth along the said slots in said input/output stage planet and said ground stage planet, wherein all said motion is with anti-friction, rolling contacts.

24. A two-stage variable displacement planet according to claim 23, wherein twist motion about an axis in the slot direction of said input/output stage planet, twist motion about an axis in the slot direction of said output stage planet, twist motion about the center of rotation of said input/output stage planet and twist motion about the center of rotation of said ground stage planet are constrained by anti-friction rolling means, wherein independent translation is permitted along the axis in the slot direction of said input/output stage planet and along the axis in the slot direction of said ground stage planet by anti-friction rolling means, wherein, twist motion about said axis in the slot direction of said input/output stage planet is constrained by the rollers of coupling gear-bearing rollers operating on the roller bearing races of the ground stage planet slot and the gear teeth of coupling gear-bearing rollers operating on the gear teeth of the gear racks in said input/output stage planet slot with the roller bearing races and gear racks in said planet interface shaft serving as an intermediary, wherein, twist motion about said axis in the slot direction of said ground stage planet is constrained by the rollers of coupling gear-bearing rollers operating on the roller bearing races of the input/output stage planet slot and the gear teeth of the coupling gear-bearing rollers operating on said the gear teeth in the gear racks in said ground stage planet slot with the roller bearing races and gear teeth in said planet interface shaft serving as an intermediary, whereby said ground stage planet and said input/output stage planet maintain proper alignment during shifting and rotation and orbiting operations, under load, wherein twist motion is constrained to the direction of planet rotation and orbiting, with planet input/output and ground stages rotating and orbiting at the same angular velocities, with each said planet stage rotating about its center of rotation, wherein said constraints are provided by the rollers of said gear-bearing rollers operating on the roller bearing races of said planet stage slots, with the roller bearing races of said planet interface shaft acting as an intermediary, whereby torque is transferred between said ground ring and said output ring, wherein the meshing teeth of said planet stage slots, said coupling gear-bearing rollers and said planet stage interface shafts constrain against wandering of said internal components during two-stage shift planet operations, whereby said input/output and said ground stage planets maintain proper alignment using anti-friction rolling contact.

25. A pair of concentric, embedded electromagnetic motors, each driving one of a pair of concentric gear-bearing two-stage epicyclical planetary transmissions according to claim 9, therein, wherein the outer electromagnetic motor powers the drive ring gear of said first moveable ground ring and the inner electromagnetic motor powers the drive ring of said second moveable ground ring, wherein said first moveable ground ring is driven with mechanical advantage and power-off, held in place, by said equilibrium locking, wherein second moveable ground ring is driven with mechanical advantage and power-off, held in place, by said equilibrium locking, wherein the movement and equilibrium locking for said first and second moveable ground rings uses anti-friction rolling contacts throughout, whereby said movement and equilibrium locking are efficient.

26. An embedded electromagnetic motor system for powering said shift system, wherein an electromagnetic motor has its stator with coils, fixed to mechanical ground, with the rotor attached to the input drive ring of a gear-bearing external two-stage epicyclical planetary transmission according to claim 14, whereby the said transmission output drive ring drives the said shift system with mechanical advantage and holds position with said equilibrium locking and efficient, anti-friction, rolling contacts.
